(19) United States
(12) Patent Application Publication
(10) Pub. No.: US 2015/0019323 A1
(43) Pub. Date: Jan. 15, 2015

(54) SECURE CONSUMER DATA AND METRICS EXCHANGE METHOD, APPARATUS, AND SYSTEM THEREFOR

(71) Applicants: Paul R. Goldberg, Palo Alto, CA (US); Frances M. Goldberg, Palo Alto, CA (US)

(72) Inventors: Paul R. Goldberg, Palo Alto, CA (US); Frances M. Goldberg, Palo Alto, CA (US)

(21) Appl. No.: 14/485,708

(22) Filed: Sep. 13, 2014

Related U.S. Application Data
(63) Continuation-in-part of application No. 14/042,667, filed on Sep. 30, 2013.
Application No. 14/042,667 is a continuation-in-part of application No. 13/802,243, filed on Mar. 13, 2013, now Pat. No. 8,799,053.

(51) Int. Cl. G06Q 30/02; H04L 29/06

(52) U.S. Cl. CPC G06Q 30/0242; H04L 63/0421
USPC 705/14.41

(57) ABSTRACT

A method, apparatus, and system for effecting targeted access to users of network connected appliances, and providing a measurement of the affect of such access, is described. A second entity supplies targeted consumer attributes of network connected appliance users who may have a heightened interest in a product or service of the second entity, a message promoting such product or service, and message impact criteria, to a first entity. The first entity communicates the message from the second entity to the appliance users without compromising the security and privacy of the appliance users. Measurements of the affect of such message, based on the message impact criteria and collected consumer data communicated from the appliance users' network connected appliances to the first entity, are communicated to the second entity. To facilitate the location, retrieval, review or interaction with the message by the network connected appliance users, the message can be a copy of a document that has been processed to prevent it from changing over time.

### CROSS-REFERENCE TO RELATED APPLICATIONS

This application is a continuation-in-part of co-pending U.S. Non-Provisional application Ser. No. 14/042,667 filed Sep. 30, 2013, which is a continuation part of U.S. Non-Provisional application Ser. No. 13/802,243 filed Mar. 13, 2013, now U.S. Pat. No. 8,799,053 issued Aug. 5, 2014.

### BACKGROUND OF INVENTION

1. Field of Invention

This invention relates to communicating messages of interest to users of network connected appliances without compromising the security and privacy of the appliance users to whom the messages are communicated to, and providing measurements of the affect of such messages.

2. Discussion of Related Art

Consumer data, that is data collected by a network connected appliance as a result of a consumer's use of the appliance, as well as part of a registration, authentication or sign-in requirement, is being provided to a wide range of entities for the purpose of promoting content, products or services offered by many of these entities. Such promotion may be effected by delivering promotional messages, often in the form of advertisements, from suppliers of goods or services; publishers of news, commentary or entertainment content; creators of news, commentary or entertainment content; or advertising agencies, among others, to users of network connected appliances through their appliances. These messages are often targeted to individual appliances users through use of such collected consumer data. The collected consumer data are analyzed to determine the interests of individual appliance users or groups of appliance users, and those appliance users that are believed to possibly have a particular interest in the content, products or services being offered are targeted with the advertisement, or advertisements, that comprise the promotional message. These advertisements may accompany, be embedded within, or be an integral part of content, such as news, multimedia entertainment, searched for information and social network feeds, viewed by the consumer.

The collected consumer data used to determine the characteristics of advertisements that best target particular appliance users include appliance users' product interests, product preferences, network browsing history, physical location and personal data. The appliance used for delivering targeted advertisements is often the same appliance that is employed to collect the appliance user's consumer data. However, the growing universe of “smart wearables”, for example sports and fitness, multimedia and entertainment, and healthcare wristbands, that often do not have the display facilities to present complex and compelling promotional messages, may serve only as appliance user consumer data collection devices. Since the collection of this data is carried out, in many cases, without the appliance user's knowledge or explicit consent, the entities collecting such data are responsible for preventing appliance users' privacy and security from being compromised during the acts of gathering and processing the data used to effectively promote their content, products or services. Therefore, this practice has caught the attention of lawmakers around the world, especially in the 30 states of the European Economic Area, the United States, Australia and South Korea, and has led to legislation directed to controlling the collection, secure use, sharing and storage of consumer data. Although there can be a high economic cost associated with violating these laws, due to an increasing number of strict regulations with harsh penalties being enacted, and there is widespread appliance user concerns related to the unauthorized use and sharing of their personal data, a large number of organizations have chosen to work toward complying with the often conflicting government regulations, instead of discontinuing the practice of collecting consumer data from network connected appliances. This course of action has, in many cases, been chosen because collected consumer data provides much of the business intelligence needed to achieve the organization's business objectives and product promotion goals. These organizations are therefore working towards incorporating meaningful data security and privacy policies into their business practices, at great expense, in an effort to achieve sufficient compliance with the government privacy regulations in the regions of the world in which they operate.

However, due to the many entities currently participating in each online advertising transaction that employ and share consumer data, attempting to comply with government privacy regulations is problematic. FIGS. 1 and 2 illustrate why this is so. FIG. 1 is a block diagram of a current example online advertising transaction, and FIG. 2 is a flowchart of a current example online advertising transaction. In the following discussion, all reference numbers between 100 and 199 designate elements of FIG. 1 and all reference numbers between 200 and 299 designate elements of FIG. 2. As can be seen from FIG. 1, the participants in an online advertising transaction may include: Advertiser 105, Media Agency 110, Demand Side Platform (DSP) 115, Data Management Platform (DMP) 120, Supply Side Platform (SSP) 125, Ad Exchange 130, Content Delivery Network 135, Publisher 140, Data Sources 150, and Network Connected Appliance 145. Advertiser 105, Media Agency 110 and Publisher 140 are shown in FIG. 1 as separate participants, although Advertiser 105 could possibly be a supplier of goods or services, a publisher of news, commentary or entertainment content, a creator of news, commentary or entertainment content, or an advertising agency, and thus encompass the roles played by Media Agency 110 and Publisher 140. However, in many online advertising transactions these participants are separate actors, thus, for reasons of completeness, they are called out separately. Consumer data collected by Network Connected Appliance 145 as a result of a consumer's use of the appliance, tracks many aspects of the appliance user's online behavior. This data is communicated over line 139 of FIG. 1 to Data Sources 150, where it is often augmented with additional specific real world appliance user consumer data collected by the entities that comprise Data Sources 150. Such entities include data services that collect and amass offline (real world) consumer data, consumer demographics, and web analytics, in addition to data services that collect and amass online consumer data. Such data services can include credit card suppliers, financial institutions, credit scoring agencies, social networking sites, gaming sites, online e-tailers, brick and mortar department stores, energy companies, utilities and super markets, among many others. DMP 120 receives augmented consumer data over line 127 from Data Sources 150, and provides raw and processed versions of the data to Advertiser 105, Media Agency 110, DSP 115, SSP 125, and Publisher 140. over lines 111, 113, 109, 123, and 153 respectively.

In Block 200 of FIG. 2, Advertiser 105 of FIG. 1 initiates an online advertising campaign with the goal of promoting their content, product or service to the maximum degree possible. In addition, Advertiser 105 defines the attributes of an audience who has a heightened interest in their content, product or service, and thus is susceptible to their advertisements. In Block 202, Media agency 110 creates the advertising campaign in accordance with Advertiser 105's targeted consumer attributes. In Block 204 Supply Side Platform (SSP) 125 determines audience reach of publishers on their platform using data from Publisher 140 and DMP 120, and obtains ad space availability, along with the specifications of the ad space, from publishers. These specifications may include the size of the available ad space, the location of the ad space with respect to other web page elements, and the content being published in the space located adjacent to and surrounding the available ad space, among others. In the example of FIGS. 1 and 2 this information is communicated to DSP 115 through DMP 120. Going through DMP 120 provides the opportunity for DMP-120 to augment the information with processed data and data from Data Sources 150 before it is communicated to DSP 115. Such processed data may include an analysis of consumer data collected from appliance users who have previously visited the publisher's website, an analysis of the demographics of the audience usually served by the publisher, an analysis of the possible affect on the advertiser's brand by the content in close proximity to the location of the available ad space, and an analysis of how advertising content and content layout can be optimized for effectiveness in the available ad space. In Block 206 DSP 115 determines an appropriate advertising campaign publisher utilizing the ad campaign received from Media Agency 110, and data from DMP 120. In Block 208 Ad Exchange 130 manages negotiations between DSP 115 and SSP 125 for the buying of ad space from a publisher on the SSP. At the conclusion of negotiations, DSP 115 selects a publisher to publish the ad campaign. In the example of FIGS. 1 and 2 Publisher 140 is selected. DSP 115 then delivers the ad campaign to Ad Exchange 130, Ad Exchange 130 delivers the ad campaign to Content Delivery Network 135 and Publisher 140 delivers the available ad space to Content Delivery Network 135, as shown in Block 210. In Block 212 Content Delivery Network combines the ad campaign from Ad Exchange 130 with the ad space from Publisher 140 and delivers the result to Publisher 140. The combined ad campaign and ad space is then published by Publisher 140 to the Web in Block 214 and the appliance user views the web published ad campaign on Network Connected Appliance 145 in Block 216.

In the above example at least 6 different entities can receive the consumer data collected by Network Connected Appliance 145, thus placing the users of the network from which the consumer data was collected at risk of having their privacy and security compromised. These entities include: DMP 120, Advertiser 105, Media Agency 110, DSP 115, SSP 125 and Publisher 140. In addition, the entities that comprise Data Sources 150, entities that collect and supply consumer data from both a consumer's use of their network connected appliance and from real world consumer activities, have access to the consumer data they collect and may supply the data to additional entities.

In addition, current online advertising transactions, as can be seen from the above example, do not provide measurements of promotional message affect, either soon after the message is delivered or over longer periods of time thereafter. Such measurements are essential for determining and improving message efficacy and targeting accuracy.

A need therefore exists for a method of communicating messages of interest to users of network connected appliances without compromising the security and privacy of the appliance users to whom the messages are communicated to, and providing measurements of the affect of such messages.

### SUMMARY OF INVENTION

The present invention effects targeted access to users of network connected appliances and provides a measurement of the affect of such access. Consumer data collected by a network connected appliance used by an appliance user resulting from the user's use of the appliance is linked with an appliance user anonymous identifier, communicated to a first entity and analyzed by use of one or more delineated parameters. De-identification processing may be performed by the first entity on the collected consumer data prior to such analysis. The results of the analysis are used to aggregate the anonymous identifier of the appliance user with a set of appliance user anonymous identifiers linked with the consumer data of other appliance users, and thereby generate an aggregate set of appliance user anonymous identifiers, wherein each appliance user anonymous identifier included in the aggregate set points to an appliance user whose collected consumer data corresponds to at least one delineated parameter in common with the collected consumer data of the other appliance users whose anonymous identifiers are included in the aggregate set. Using the anonymous identifiers, the first entity can effect targeted access by a second entity to the appliance users whose anonymous identifiers are included in the aggregate set, by communicating a message to the appliance users from the second entity. The message can be a copy of a document that has been processed to prevent it from changing over time. In addition, the message can be accompanied by metadata derived from analysis of the message content. Communicating a stable version of the message from the second entity to the appliance users, along with metadata derived from analysis of the message content, provides the appliance users with the ability to find, retrieve, display, and interact with an unchanged version of a previously viewed message.

The first entity can provide the second entity a measurement of message affect by use of one or more message impact criteria and collected consumer data of the appliance users whose anonymous identifiers are included in the aggregate set. Since the date and time the first entity communicates a message from the second entity to the appliance users is recorded and stored by the first entity, and the collected consumer data includes the date and time a consumer data element is collected, as well as if and when the appliance user viewed the message, the present invention can generate a measurement of the affect a message has on the online behavior of the appliance users who viewed the message after message viewing, in addition to measurements of message reach and message viewer interaction. In order to assure that the collected consumer data of the appliance users whose anonymous identifiers are included in the aggregate set reflects the current online behavior of the appliances users, and thereby allow accurate message targeting and affect measurement, consumer data can be periodically purged.

The second entity can be any organization or individual desirous of communicating, for example, a message relating to their content, goods, services, political philosophy, religious philosophy, values, concepts, or ideas, to the users of network connected appliances who display certain targeted consumer attributes, and obtaining a measurement of message affect. The second entity can be broadly thought of as an “advertiser”, such as an automobile manufacturer, a consumer packaged goods manufacturer, or a prescription drug company. However, organizations that may not be thought of as advertisers, such as political action committees, environmental advocacy groups, or government agencies, can also be “advertisers” in the context of the present invention. One or more targeted consumer attributes, delineated parameters, or message impact criteria, can be communicated from the second entity to the first entity. When targeted consumer attributes are communicated from the second entity to the first entity, the first entity can employ the targeted consumer attributes to derive one or more delineated parameters used to generate the aggregate set of appliance user anonymous identifiers. When one or more delineated parameters are communicated from the second entity to the first entity, the first entity can directly use the delineated parameters to generate the aggregate set. When one or more message impact criteria are communicated from the second entity to the first entity, the first entity can employ the message impact criteria to generate the measurement of message affect.

The first entity, a service provider called a Secure Consumer Data and Metrics Exchange, or SCDME, may, for example, be a cloud services company, such as AT&T Cloud Services, Amazon Web Services, or Google Cloud Platform. It could also be one or a combination of organizations. Such organizations can include advertisers, media agencies, demand side platforms, data management platforms, supply side platforms, ad exchanges, content delivery networks, publishers, data sources, search engines, and social networks, among others.

The network connected appliance of the present invention for collecting and communicating to the first entity an appliance user's consumer data resulting from the user's use of the appliance, and displaying a communication received from the first entity, can be comprised of a processor, a memory, a network communications interface, a display screen, and a computer program stored in the memory and executed on the processor. Such a computer program could, for example, be downloaded from the first entity in the form of a software application. When these elements are employed to implement the network connected appliance of the present invention, the processor obtains authorization from the appliance user to collect and communicate the appliance user's consumer data to the first entity; the processor generates an appliance user anonymous identifier; the processor collects appliance user's consumer data; the processor links the generated appliance user anonymous identifier with the collected consumer data; the processor communicates the collected consumer data with the appliance user's anonymous identifier to the first entity by use of the network communications interface; and the processor uses the network communications interface to receive communications from the first entity and display the received messages on the display screen. These communications can include a message from a second entity. Such messages can be product, service or other advertisements provided to the first entity from the second entity for dissemination to appliance users who exhibit certain targeted consumer attributes, and may therefore have a heightened interested in the second entity's product or service.

In order to facilitate appliance user interaction with the received messages the processor categorizes each received message based on message content, and displays the message to the appliance user on the display screen in a category. Over time, these categories can be populated with messages communicated to the network connected appliance from one or more second entities. To assist such categorization by the processor, the received message can be accompanied by metadata derived from the message contents. The processor can additionally use the metadata to select a message for display to the appliance user. This metadata can be generated by the first entity prior to the first entity communicating the message from the second entity to the network connected appliance.

The message from the second entity communicated to the processor by the first entity may be a copy of a document that has been processed to prevent it from changing over time. A document processed in this manner can provide the appliance user with the ability to find, retrieve, display, and interact with an unchanged version of a previously viewed message. Having an unchanged version of a previously viewed message is particularly important if the message is, for example, an ad campaign website page. Such a message is susceptible to “web page aging” and “hyperlink aging”, meaning that both the main web page's content, and the content of the web pages pointed to by the hyperlinks incorporated in the main web page, can change over time. The time period over which this change can occur is often quite short, making it very difficult for the appliance user to obtain the information needed to support a buying decision, unless such decision is made very soon after viewing the initially provided ad campaign website page.

The appliance user may use more than one network connected appliance of the present invention. The processor in each of these network connected appliances is directed to generate a unique appliance user anonymous identifier by the app of the present invention at the time of app installation. When the appliance user uses more than one appliance of the present invention, appliance user consumer data collected by a particular appliance used by the appliance user is linked to the appliance user's unique anonymous identifier resident on that particular appliance. Since the first entity's analysis of the appliance user's online behavior becomes more accurate the greater the volume of appliance user consumer data analyzed, it is advantageous to combine the consumer data collected from each network connected appliance used by the appliance user into a single combined set of consumer data linked to only one of the appliance user's anonymous identifiers. The processor facilitates such combining of appliance user consumer data by transferring the appliance user anonymous identifier from a first appliance of the present invention used by the appliance user to a second appliance of the present invention used by the appliance user. Consumer data received by the first entity from the first and second network connected appliances will then be combined by the first entity, since the first entity does not differentiate between data linked to the same anonymous identifier from different sources.

Although appliance user online behavior analysis by the first entity becomes more accurate the greater the volume of appliance user consumer data analyzed, the collected consumer data stored by the first entity linked to the appliance users anonymous identifier may become less representative of the appliance user's, likes, dislikes, desires and needs. This is because much of the consumer data collected by the user's network connected appliance reflects the appliance user's current activities, age, socioeconomic level, education level, occupation, peer group pressures, and short term plans. If this should occur, the appliance user's anonymous identifier may be aggregated with a set of anonymous identifiers that point to appliance users whose collected consumer data indicate they should receive a message that would not be of interest to the appliance user. To reduce the incidence of such incorrectly targeted messages, the processor of the present invention, under the direction of the appliance user, can communicate a directive to the first entity to erase the collected consumer data of the appliance user that has been collected over a defined period of time.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a current example online advertising transaction [Prior Art];

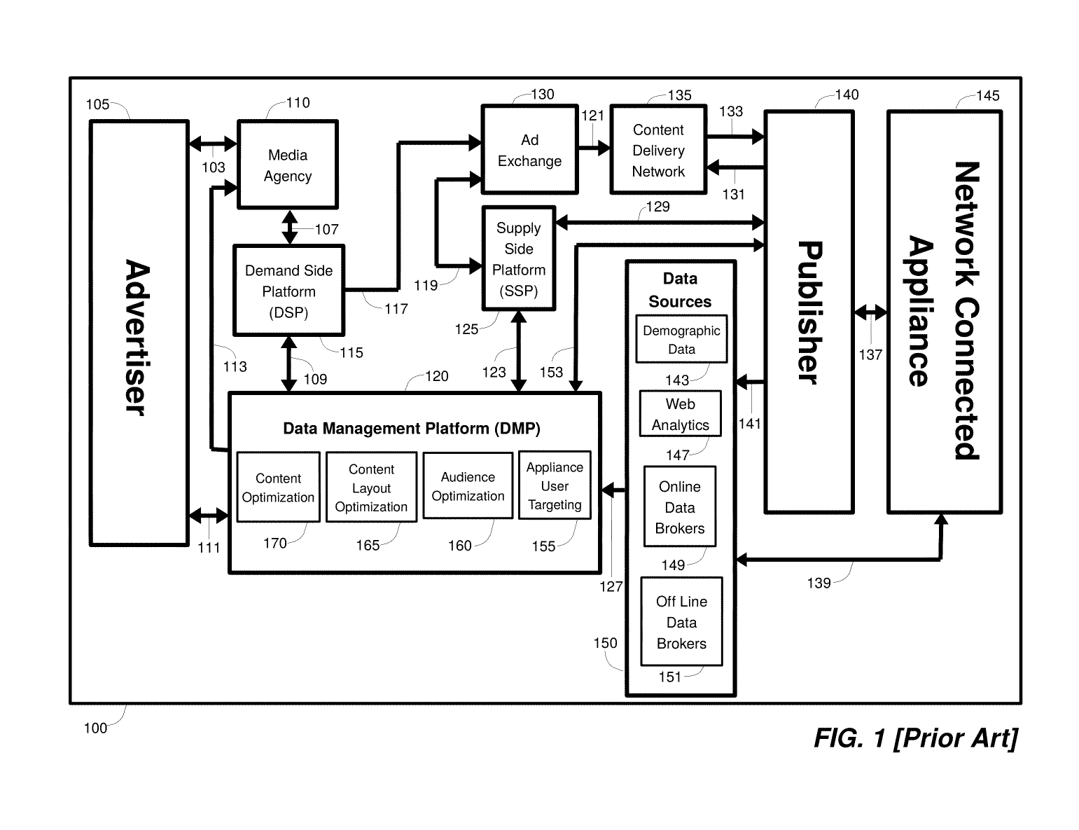

FIG. 2 is a flowchart of a current example online advertising transaction [Prior Art];

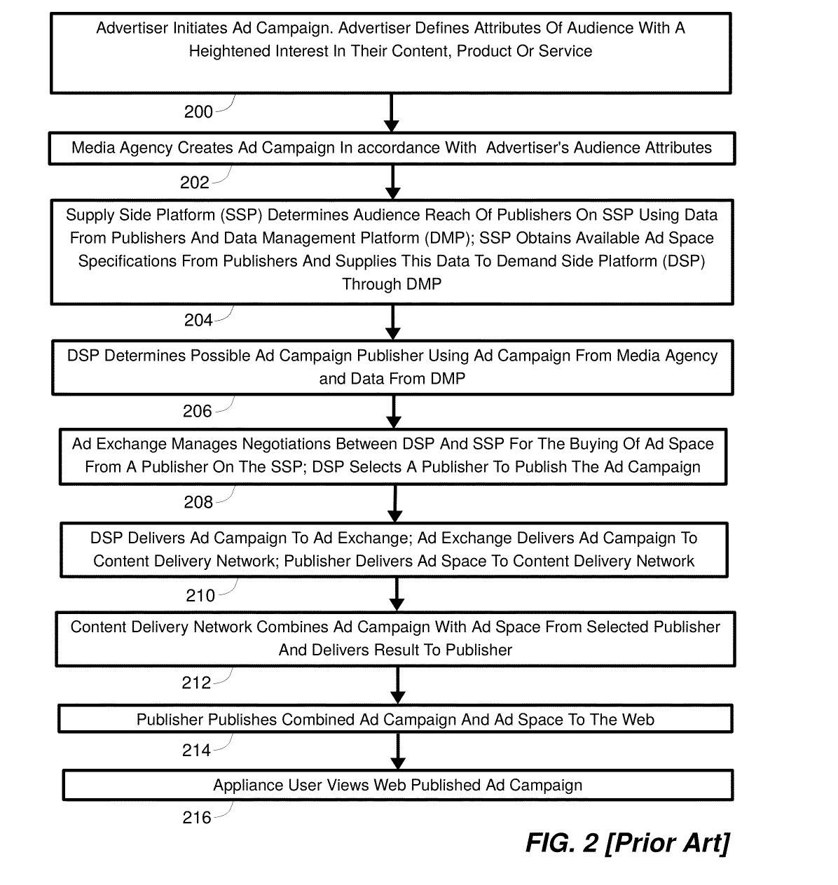

FIG. 3 is an online advertising transaction block diagram of the preferred embodiment of the present invention;

FIG. 4 is an online advertising transaction flowchart of the preferred embodiment of the present invention;

FIG. 5 is a block diagram of a Secure Consumer Data and Metrics Exchange of the preferred embodiment of the present invention;

FIG. 6 is a block diagram of a network connected appliance of the preferred embodiment of the present invention;

FIG. 7 is a process flowchart of a network connected appliance of the preferred embodiment of the present invention;

FIGS. 8A and 8B illustrate example displays presented to a user of a network connected appliance of the preferred embodiment of the present invention.

### DESCRIPTION OF THE PREFERRED EMBODIMENT

The present invention will now be described more fully hereinafter with reference to the accompanying drawings, which form a part thereof, and which show, by way of illustration, a specific embodiment by which the invention may be practiced. The invention may, however, be embodied in many different forms and should not be construed as limited to the embodiment set forth herein; rather, this embodiment is provided so that this disclosure will be thorough and complete, and will fully convey the scope of the invention to those skilled in the art. Among other things, the present invention may be embodied as methods or devices. Accordingly, the present invention may take the form of an entirely hardware embodiment, and entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or”, unless the context clearly dictates otherwise. The term “based on” is not exclusive and allows for being based on additional factors not described, unless the context clearly dictates otherwise. In addition, throughout the specification, the meaning of “a”, “an”, “and” and “the” include plural references. The meaning of “in” includes “in” and “on”. Also, the use of “including”, “comprising”, “having”, “containing”, “involving”, and variations thereof herein, is meant to encompass the items listed thereafter and equivalents thereof as well as additional items.

In the discussion of the preferred embodiment of the present invention that follows, the term “second entity” could be replaced with the term “advertiser”, although any organization seeking access to appliance users who are members of a targeted audience, complies with the definition of “second entity” for the purposes of this discussion. Further, the term “message” could be replaced with the term “ad campaign website page”, “ad campaign”, “advertisement” or “ad”, although any message, in the form of text, images, graphics, audio, video, multimedia, or a combination thereof, for example, whether or not it is ad campaign related, whether or not it resides on a World Wide Web website, complies with the definition of “message” for the purposes of this discussion.

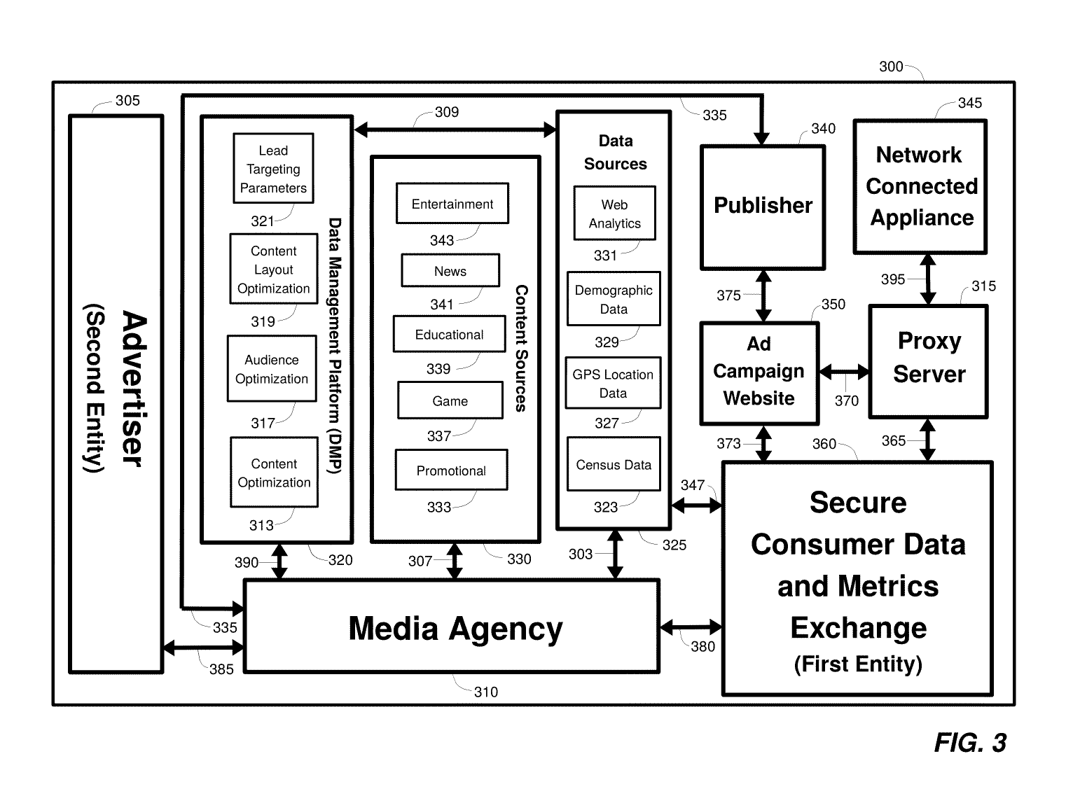

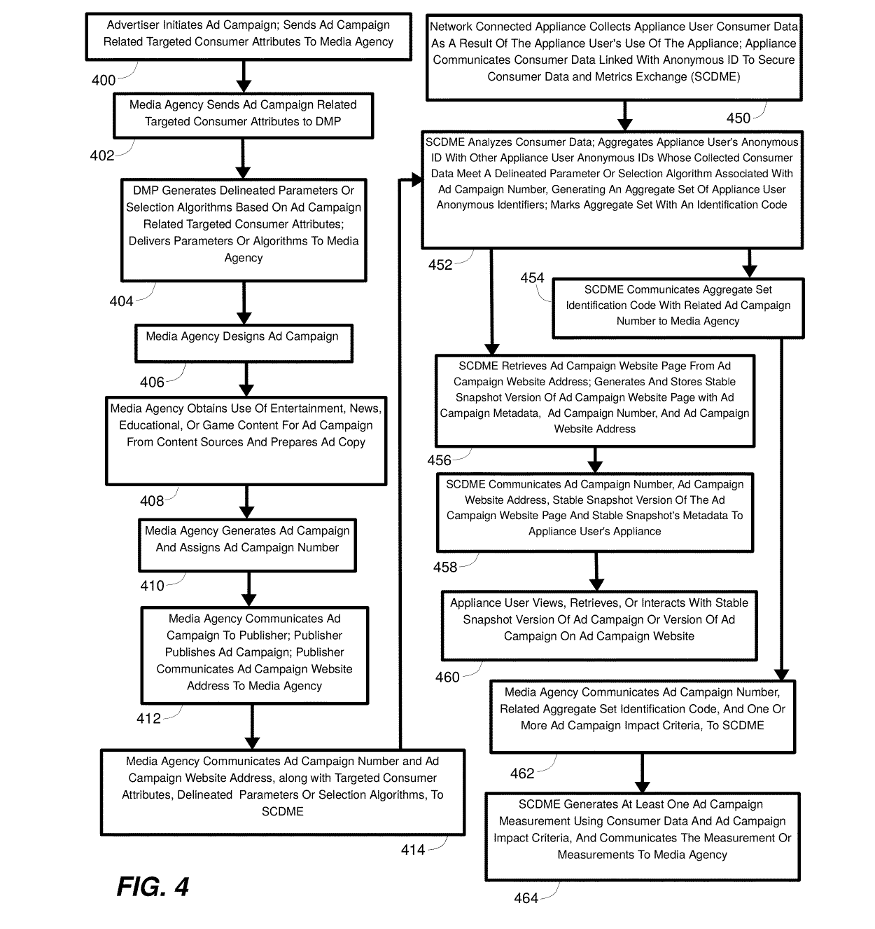

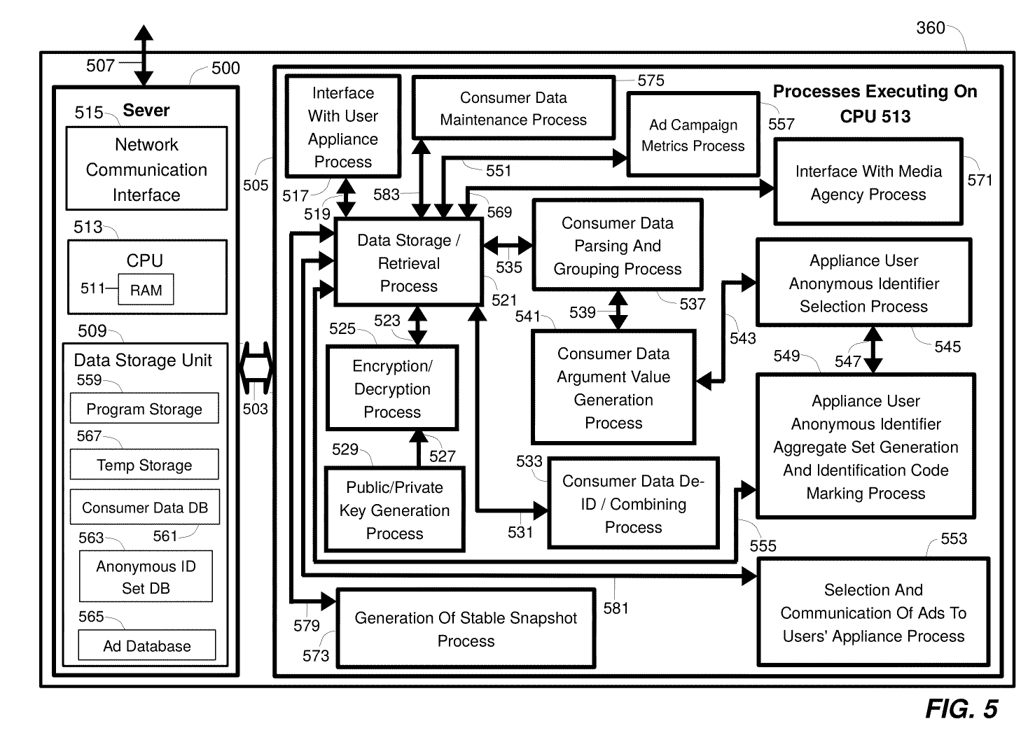

FIGS. 3 and 5, in conjunction with the flow chart of FIG. 4, are employed in the following discussion to illustrate the operation of the preferred embodiment of the present invention in the context of an online advertising transaction. Although an online advertisement transaction is used for purposes of clarity, the present invention is directed towards targeted access for the purpose of message delivery in general, therefore the following discussion should not be read as being limited to targeted access for the purpose of only advertisement delivery. FIG. 3 is an online advertising transaction block diagram of the preferred embodiment. FIG. 5 is a block diagram of a Secure Consumer Data and Metrics Exchange of the preferred embodiment, and FIG. 4 is an online advertising transaction flowchart of the preferred embodiment. In this discussion, all reference numbers between 300 and 399 designate elements of FIG. 3, all reference numbers between 400 and 499 designate elements of FIG. 4, and all reference numbers between 500 and 599 designate elements of FIG. 5.

As can be seen from FIG. 3, the entities participating in an online advertising transaction of the present invention are Advertiser 305, Media Agency 310, Data Management Platform (DMP) 320, Data Sources 325, Content Sources 330, Publisher 340, Network Connected Appliance 345, Proxy Server 315, and Secure Consumer Data and Metrics Exchange (SCDME) 360. In following discussion of the preferred embodiment of the present invention, Media Agency 310 works on behalf of Advertiser 305. Consumer data is collected by Network Connected Appliance 345 as a result of a consumer's use of the appliance and linked by Network Connected Appliance 345 with an appliance user anonymous identifier, as shown in Block 450 of FIG. 4. In addition to the appliance user anonymous identifier, collected consumer data may include, for example, the websites the appliance user visited; what news articles, entertainment content product descriptions and advertisements were clicked on by the appliance user; the search terms used by the appliance user while searching for Internet content; what products or services were purchased by the appliance user online; what social networking websites, association websites, and blogs the appliance user visited; how long the appliance user remained connected to each website; the physical location of the appliance user at predetermined time intervals; what “brick and mortar stores” the appliance user visited, and the date and time each element of collected consumer data was acquired and stored.

In FIG. 3. the appliance user's collected consumer data with anonymous identifier is communicated over line 395 to Proxy Server 315, and then from Proxy Server 315 this data are communicated over line 365 to first entity SCDME 360. Proxy Server 315 is employed to reduce the possibility that information regarding the Internet Protocol address (IP address) employed by the network connected appliance used by the appliance user will be available to SCDME 360. This can enhance the appliance user's anonymity and thereby provide the appliance user with increased security, reducing appliance user concerns that their collected consumer data may be associated with them. Strictly speaking Proxy Server 315 is not necessary for the proper operation of the present invention. SCDME 360 analyzes the consumer data and aggregates the appliance user's anonymous identifier with a set of other appliance user anonymous identifiers whose collected consumer data corresponds to at least one common delineated parameter. The aggregation process is based on the results of the analysis. These actions are indicated in Block 452. Delineated parameters used in the analysis and aggregation processes can be communicated to SCDME 360 from Media Agency 310, working on behalf of Advertiser 305, the Second Entity in this discussion This data is communicated between Media Agency 310 and SCDME 360 over line 380.

As used in this discussion, the term targeted consumer attributes denotes characteristics inherent in the group of consumers Advertiser 305, or Media Agency 310 on behalf of Advertiser 305, wishes to target with an advertising campaign. Therefore, if Advertiser 305 asks Media Agency 310 to promote a new restaurant in Palo Alto, Calif., henceforth referred to as the “Palo Alto example”, such targeted consumer attributes could include: liking a wide variety of cuisines; enjoying 2 star or above restaurants; living, working, shopping, or dining in or in the vicinity of Palo Alto, Calif.; and, eating at restaurants often. Delineated parameters are numeric quantities assigned to actions associated with individuals who display particular targeted consumer attributes. Therefore in the current example, delineated parameters could include: visiting restaurant review websites (Yelp for example) at least once a week; viewing menus from Palo Alto restaurants whose prices range from $11 to $60 per meal without drinks; viewing 2 or more restaurant websites per month for more than 5 minutes each; viewing the websites of multiple restaurants, wherein at least 3 of the restaurants viewed serve different cuisines from each other; being physically in Palo Alto, or within 10 miles from Palo Alto, at least 3 times a week; and remaining at a location for between 30 and 90 minutes, at least once a week, where at such location at least 1 restaurant is known to be located.

If Media Agency 310 wishes the aggregate set of appliance user anonymous identifiers generated by SCDME 360 to reflect a broad range and large number of appliance users, Media Agency 310 could ask SCDME 360 to include in the aggregate set the anonymous identifiers of all appliance users whose collected consumer data satisfies a single delineated parameter. For example, the aggregate set could be comprised of the anonymous identifiers of appliance users who are physically in Palo Alto, or within 10 miles from Palo Alto, at least 3 times a week. Should Media Agency 310 desire a more focused aggregate set of appliance user anonymous identifiers, SCDME 360 could employ a second delineated parameter in addition to the first delineated parameter. In this case, only the anonymous identifiers of appliance users whose collected consumer data satisfies both delineated parameters would be included in the set. Therefore, the more focused aggregate set of appliance user anonymous identifiers may only include the anonymous identifiers of appliance users who are physically in Palo Alto, or within 10 miles from Palo Alto, at least 3 times a week, and view 2 or more restaurant websites per month for more than 5 minutes each. Although 2 delineated parameters have been discussed, any number of delineated parameters could be employed in the analysis and aggregation processes making it possible to generate very focused sets of appliance user anonymous identifiers.

As shown in Block 414 of FIG. 4, Media Agency 310 communicates one or more targeted consumer attributes, or one or more delineated parameters, along with an ad campaign number relating the attributes or delineated parameters to a particular ad campaign, to SCDME 360. SCDME 360 employs these targeted consumer attributes or delineated parameters to analyze consumer data received from Network Connected Appliance 345 and determine if the anonymous identifier associated with the user of Appliance 345 should be included in the aggregate set of anonymous identifiers that represent appliance users with an interest in content, product or services offered by Advertiser 305, as shown in Block 452. In the case of Media agency 310 communicating targeted consumer attributes to SCDME 360, SCDME 360 would derive delineated parameters from these targeted consumer attributes to use in the set aggregation process. In the case of Media Agency 310 communicating delineated parameters to SCDME 360, SCDME 360 would use these received delineated parameters directly. Block 414 also shows that Media Agency 310 may communicate one or more selection algorithms to SCDME 360, although SCDME 360 could develop and employ their own selection algorithm. A selection algorithm can be employed by SCDME 360 for determining the anonymous identifiers to be included in the aggregate set. Such an algorithm may use numeric input arguments derived from delineated parameters to effect such selection. The algorithm may use a single argument or multiple arguments. Further, the algorithm may assign weights to the arguments, such that some arguments have more influence on the selection results than others. In addition, the algorithm may base the weighting of some of the arguments on the value of one or more of the other arguments.

The algorithm may be defined in the form of a computer procedure. An example computer procedure is defined below, using the “Palo Alto example”. In this example, written in the Scheme programming language conforming to the “Revised⁵ Report on the Algorithmic Language Scheme”, edited by Richard Kelsey, William Clinger, and Jonathan Rees, dated Feb. 20, 1998, the computer procedure is written as a Scheme “predicate”. By convention, Scheme procedures that always return a Boolean as their value are called predicates and their names usually end in?” The defined Scheme predicate “add-to-aggregate-set?” employs numeric input arguments whose ranges are predetermined. The procedure returns “#t”, the Scheme notation for “True”, should the calculated value derived from the numeric input arguments included in the call to the procedure equal or exceed a threshold value and meet some other criteria, and “#f”, the Scheme notation for “False”, should the calculated value derived from the numeric input arguments included in the call to the procedure not equal or exceed a threshold value or not meet some other criteria. If the procedure indicates #t, the appliance user's anonymous identifier is included in the aggregate set of appliance user anonymous identifiers generated by SCDME 360. If the procedure indicates #f, the appliance user's anonymous identifier is not included in the aggregate set of appliance user anonymous identifiers generated by SCDME 360.

In the following example Scheme procedure, ap1 through ap6, w1 through w6, “apmax” and “portion” are arguments included in the call to the procedure. In the case of the arguments ap1 through ap6, each of these arguments indicates the degree the appliance user's collected consumer data satisfies a delineated parameter used in the “Palo Alto example”. Specifically:
ap1=a number from 0 to 100, where 0 indicates the appliance user's collected consumer data shows the appliance user does not visit restaurant review websites, and 100 means the appliance user's collected consumer data shows, on average, the appliance user visits at least 10 restaurant review websites per month;
ap2=a number from 0 to 100, where 0 indicates the appliance user's collected consumer data shows the appliance user does not view Palo Alto restaurant menus whose prices range from $11 to $60 per meal without drinks online, and 100 indicates the appliance user's collected consumer data shows the appliance user views, on average, Palo Alto restaurant menus whose prices range from $11 to $60 per meal without drinks online at least 5 times per month;
ap3=a number from 0 to 100, where 0 indicates the appliance user's collected consumer data shows the appliance does not view restaurant websites and 100 indicates the appliance user's collected consumer data shows the appliance user views, on average, at least 10 restaurant websites, for more than 5 minutes each, per month;
ap4=a number from 0 to 100, where 0 indicates the appliance user's collected consumer data shows the appliance user always views the websites of restaurants that serve the same type of cuisine, and 100 indicates the appliance user's collected consumer data shows the appliance user views, over a period of 3 months, the websites of at least 5 restaurants whose cuisines are different from each other;
ap5=a number from 0 to 100, where 0 indicates the appliance user's collected consumer data shows the appliance user is never physically in Palo Alto, or within 10 miles from Palo Alto, and 100 indicates the appliance user's collected consumer data shows the appliance user is physically in Palo Alto, or within 10 miles from Palo Alto at least 5 times per week;
ap6=a number from 0 to 100, where 0 indicates the appliance user's collected consumer data shows the appliance user never remains at a location for between 30 and 90 minutes, where at such location at least 1 restaurant is known to be located, and 100 indicates the appliance user's collected consumer data shows the appliance user remains at a location for between 30 and 90 minutes, where at such location at least 1 restaurant is known to be located, at least 3 times per week.

In the case of the arguments w1 through w6, each of these arguments are weights assigned to procedure arguments ap1 through ap6. These weights alter the influence each ap argument has on the result of the procedure. Specifically:
w1, w2, w3, w4, w5, w6 are ap1, ap2, ap3, ap4, ap5, ap6 argument weightings respectively, each with a value from 0 to 2, where 0 indicates that 0% of the ap argument's value influences the procedure result and 2 indicates that 200% of the ap argument's value influences the procedure result.

In the case of the argument “apmax”, this argument is the maximum value assigned to each delineated parameter. In the example Scheme procedure, each delineated parameter is assigned the same maximum value, the minimum being 0, so only one apmax value is used. However, each delineated parameter may be assigned a different maximum value. Therefore, as many apmax values as there are delineated parameters could be included in the procedure.

In the case of the argument “portion”, this argument is a number between 0 and 1. The sum of maximum delineated parameter values, assigned to the variable “tapmax” in the example Scheme procedure, multiplied by “portion” equals the threshold value that needs to be attained or exceeded for the consumer's anonymous identifier to be included in the aggregate set of consumer anonymous identifiers.

The example Scheme procedure is defined as follows:

```
(define add-to-aggregate-set?
  (lambda (apmax portion ap1 w1 ap2 w2 ap3 w3 ap4 w4 ap5 w5 ap6
  w6)
; weight arguments; calculate “total apmax” = tapmax
```

(let* ((ap1w (* ap1 w1)) (ap2w (* ap2 w2))

```
  (ap3w (* ap3 w3)) (ap4w (* ap4 w4))
  (ap5w (* ap5 w5)) (ap6w (* ap6 w6))
  (tapmax (* apmax (length (list ap1 ap2 ap3 ap4 ap5 ap6)))))
```

; add appliance user anonymous identifier to aggregate set?

(cond

((and (>= ap1w 50)

(>= ap4w 60)
(>= ap6w 33)
(>= (+ ap1w ap2w ap3w ap4w ap5w ap6w) (* tapmax
portion)))

#t) ; yes, add anonymous identifier
(else #f))))) ; no, do not add anonymous identifier

In the above example Scheme procedure, the values of arguments ap1, ap2, ap3, ap4, ap5, and ap6, are obtained from the analysis of the appliance user's collected consumer data received over line 365. As previously stated, ap1 is defined as a number from 0 to 100, where 0 indicates the appliance user's collected consumer data shows the appliance user does not visit restaurant review websites, and 100 means the appliance user's collected consumer data shows, on average, the appliance user visits at least 10 restaurant review websites per month. Therefore, for collected appliance user consumer data that, when analyzed, shows the appliance user visits, on average, 5 restaurant review websites per month, ap1 could be assigned a value of 50 as a result of the analysis process.

Using the descriptions in the previous paragraphs for ap2 through ap6, and reasoning similar to that employed in the previous paragraph to assign a value to ap1, values could be assigned to ap2 through ap6 as follows:
a) If the collected appliance user's consumer data shows that the appliance user views, on average, Palo Alto restaurant menus whose prices range from $11 to $60 per meal without drinks online at least 2 times per month, ap2 could be assigned a value of 40 as a result of the analysis process;
b) If the collected appliance user's consumer data shows that the appliance user views, on average, at least 5 restaurant websites, for more than 5 minutes each, per month ap3 could be assigned a value of 50 as a result of the analysis process;
c) If the collected appliance user's consumer data shows that the appliance user views, over a period of 3 months, the websites of 3 restaurants whose cuisines are different from each other, ap4 could be assigned a value of 60 as a result of the analysis process;
d) If the collected appliance user's consumer data shows that the appliance user is physically in Palo Alto, or within 10 miles from Palo Alto, 2 times per week, apt 5 could be assigned a value of 40 as a result of the analysis process; and
e) If the collected appliance user's consumer data shows that the appliance user remains at a location for between 30 and 90 minutes, where at such location at least 1 restaurant is known to be located, 1 time per week, apt 6 could be assigned a value of 33 as a result of the analysis process.

The values of arguments w1, w2, w3, w4, w5, and w6, alter the importance of arguments ap1, ap2, ap3, ap4, ap5 and ap6 respectively. The more important an “op” argument is the greater the influence it has on the result of the “add-to-aggregate-set?” procedure. For example, Media Agency 310 may voice a desire to SCDME 360 to increase the number of anonymous identifiers in the aggregate set that are linked to the consumer data of appliance users who are physically in Palo Alto, or within 10 miles from Palo Alto on at least a weekly basis. This can be accomplished by changing the value of argument w5. If, for example, w5 was 1.0, argument ap5's effective influence on the result of the procedure would be 100% of its numerical value. By increasing w5 to 1.3, ap5's effective influence on attaining or exceeded the threshold value that needs to be reached for the consumer's anonymous identifier to be included in the aggregate set of consumer anonymous identifiers, would be increased by 30% to 130% of its numerical value. Thus, the number of anonymous identifiers in the aggregate set that are linked to the consumer data of appliance users who are physically in Palo Alto, or within 10 miles from Palo Alto on at least a weekly basis would increase.

The value of the argument “apmax” sets the maximum value of arguments ap1, ap2, ap3, ap4, ap5 and ap6. For ease of discussion, the “add-to-aggregate-set?” procedure is written such that all the “ap” arguments have the same maximum value, where this value is set by the use of a single “apmax” argument. In general, this need not be the case. The procedure could have been written to allow the maximum value of each “ap” argument to be different and set by separate arguments in the procedure call. Although “apmax” can be any value, a good value for the example procedure under discussion would be 100.

The value of the argument “portion” determines the threshold value that needs to be attained or exceeded for the appliance user's anonymous identifier to be included in the aggregate set of appliance user anonymous identifiers. An inspection of the “add-to-aggregate-set?” procedure's Scheme code shows how the argument “portion” plays this role. The Scheme code fragment:

(>=(+ap1wap2wap3wap4wap5wap6w)(*tapmax portion))

calls for multiplying variable “tapmax” by argument “portion”, where “tapmax” has been previously set in the procedure to:

(tapmax(*apmax(length(list ap1ap2ap3ap4ap5ap6))))

or, using mathematical notation, to tapmax=(apmax*the number of ap arguments). In other words, since, for this example, apmax is the same value for each ap argument used in the “add-to-aggregate-set?” procedure, tapmax is equal to the single apmax argument times the number of ap arguments used in the procedure. Referring back to the Scheme code fragment above, it can be seen that the argument “portion” has the affect of setting the value that needs to be attained or exceeded for the appliance user's anonymous identifier to be included in the aggregate set of appliance user's anonymous identifiers, since if the sum of weighted arguments apw1, apw2 apw3, apw4, apw5 and apw6 is equal to or exceeds (*tapmax portion), or in mathematical notion (tapmax*portion), the appliance user's anonymous identifier is included in the aggregate set. If it does not, the appliance user's anonymous identifier is not included.

To demonstrate how the argument “portion” acts to set the threshold value, and thereby alter the number of appliance user anonymous identifiers included in the set of anonymous identifiers, recall that in the call to the “add-to-aggregate-set?” procedure there are 6 arguments, ap1-ap6. These six arguments are derived from an analysis of the appliance user's collected consumer data based on 6 delineated parameters. Also recall that a good value for “apmax” is 100. Letting apmax equal 100 causes “tapmax” to equal 600, a constant value throughout the execution of the procedure. If the argument “portion” is chosen to be 0.50, the threshold value that needs to be attained or exceeded for the appliance user's anonymous identifier to be included in the aggregate set of appliance user anonymous identifiers is 300. Lowering the value of “portion” to, for example, 0.25, decreases the threshold value to 150 and thereby potentially increases the number of included appliance user anonymous identifiers by as much as 1.5 times. The actual amount of increase depends on a number of factors including: the number of appliance user consumer data sets employed in the consumer data analysis, the number of delineated parameters employed in the analysis, and the distribution uniformity of the consumer data with respect to the employed delineated parameters.

Included in the “add-to-aggregate-set?” procedure is another filtering process to further focus the generated aggregate set of anonymous appliance user identifiers in accordance with Media Agency 310's wishes. This filtering process is embodied in the following Scheme code fragment:

(and (>= ap1w 50)

(>= ap4w 60)
(>= ap6w 33)
(>= (+ ap1w ap2w ap3w ap4w ap5w ap6w) (* tapmax portion)))

The last line of the “and” statement is the code fragment discussed in the preceding 2 paragraphs. For this “and” statement to result in a #t output, and thereby cause the execution of the “add-to-aggregate-set?” procedure to result in a #t output, all lines of the statement must be true. Specifically, ap1w must be greater than or equal to 50, apw4 must be greater than or equal to 60, apw6 must be greater than or equal to 33 and the sum of ap1w through ap6w must be greater than or equal to (tapmax*portion). Assuming the last line of the “and” statement is satisfied and the weights applied to arguments ap1, ap4 and ap6 are 1, Media Agency 310 could request, for example, that the aggregate set of appliance user anonymous identifiers at least include the anonymous identifiers of appliance users whose consumer data indicates that the appliance user visits, on average, 5 restaurant review websites per month (ap1w>=50), the appliance user views, over a period of 3 months, the websites of 3 restaurants whose cuisines are different from each other (ap4w>=60), and the appliance user remains at a location for between 30 and 90 minutes, where at such location at least 1 restaurant is known to be located, 1 time per week (apt6w>=33).

As previously discussed, “add-to-aggregate-set?” procedure argument values ap1 through ap6 are generated by the analysis of appliance user consumer data communicated to SCDME 360 from Network Connected Appliance 345, through Proxy Server 315, over lines 395 and 365. Since Appliance 345 has access to Internet downloaded, appliance user generated, appliance user location, and appliance generated data sources, among other data sources, consumer data may be collected by Appliance 345 in many different formats. Such source formats could include text, binary, xml, sgml, html, portable document format (pdf), and Open Document Format (ODF), to name a few. For ease of analysis by SCDME 360, data in these disparate formats is converted by Appliance 345 into a common format before being communicated to SCDME 360, although SCDME 360 could receive variably formatted data from Appliance 345 and convert the data into a common format for analysis. In the preferred embodiment of the present invention herein discussed, Appliance 345 converts collected consumer data into the comma delimited Comma Separated Value (CSV) text file format, where each data element is separated from the following data element by an ASCII comma character. Other data file formats can be used. The first data element of the CSV text file communicated to SCDME 360 from Appliance 345 through Proxy Server 315 is the appliance user's anonymous identifier, although the appliance user's anonymous identifier could appear as the last element of the file, or in any other predefined position of the file. The second element is a date and time stamp data element, where the date and time stamp data is generated by Appliance 345's real time clock. This element designates the date and time the following data element was collected by Appliance 345. The third element of the CSV text file contains a first collected consumer data element. The fourth element is a date and time stamp data element, and the fifth element is a second collected consumer data element. The pattern of date and time stamp data element followed by collected consumer data element continues throughout the rest of the file. The collected consumer data element could contain, for example, the Uniform Resource Locater (URL) address of a web page on the world wide web visited by the appliance user, the URL of a hyperlink on the visited web page over which the appliance's pointing device passed or the appliance user clicked on, the length of time the appliance user remained on a particular web page, the Universal Product Code (UPC) of a product or service purchased by the appliance user while using the appliance, the Global Positioning System (GPS) coordinates of the appliance user at the location where the appliance user is using the appliance, or the appliance user's location coordinates derived from the positions of cell towers and Wi-Fi access points at the location where the appliance user is using the appliance. The collected consumer data element could also contain other data related to the appliance user's use of the appliance. After collecting appliance user consumer data for a predetermined period of time, collecting a predetermined number of consumer data elements, or collecting consumer data elements until a predetermined event occurs, and forming one or move CSV text files, each containing collected appliance user consumer data with the appliance user's anonymous identifier, Appliance 345 encrypts the data and communicates the encrypted data to SCDME 360 through Proxy Server 315.

SCDME 360 receives the encrypted CSV files from Network Connected Appliance 345 through Proxy Server 315, stores the files in encrypted form on Data Storage Unit 509 in Temporary Storage (Temp Storage) 567 of FIG. 5, and decrypts the files by use of Computer Processor Unit (CPU) 513, readying the appliance user consumer data contained in the CSV files for analysis. Strictly speaking, the storage of received appliance user consumer data in encrypted form is not required. However, such encrypted data storage increases the privacy and security of the data stored on Data Storage Unit 509, which is an important factor in: a) providing the user of Appliance 345 with confidence that their consumer data is protected and unavailable to entities that should not have access to their data, and b) facilitating compliance with government consumer data privacy and security legislation and regulations.

The following SCDME 360 processes are performed on Server 500 of FIG. 5. Outlined double headed Arrow 503 indicates that Processes 505 take the physical form of software stored on Data Storage Unit 509 in Program Storage 559 executed on CPU 513 using Random Access Memory (RAM) 511. As shown in FIG. 5, Interface With User Appliance Process 517 uses Network Communication Interface 515 in conjunction with Network Connection line 507, and Data Storage/Retrieval Process 521, to effect communication with Network Connected Appliance 345 through Proxy Server 315 over Line 365 and store received encrypted CSV files in Temp Storage 567. Inter-process Communication 519 serves as the data conduit between Process 517 and Process 521. Data Storage/Retrieval Process 521 retrieves the encrypted CSV files from Temp Storage 567 and through Inter-process Communication 523 delivers the encrypted CSV files to Encryption/Decryption Process 525. Process 525 decrypts the CSV files and through Inter-process Communication 523 returns the decrypted CSV files to Data Storage/Retrieval Process 521. Process 521 then stores the decrypted CSV files in Temp Storage 567. Subsequently, Data Storage/Retrieval Process 521 retrieves the decrypted CSV files from Temp Storage 567 and through Inter-process Communication 531 delivers the decrypted CSV files to Consumer Data De-Identification (De-ID)/Combining Process 533.

Process 533 performs de-identification processing on the consumer data contained within the CSV files. De-identification processing disassociates the consumer data contained in the CSV files from the identity of the appliance user from whom the data was collected. The processing may, for example, include the removal of: the appliance user's name; references to the appliance user's residence location such as street address, city, county, parrish, precinct, or zip code; numbers relating to the appliance user such as the appliance user's date of birth, date of admission to a school of higher learning, dates of admission and release from a heath care facility, fax numbers, email addresses, social security numbers, driver license numbers, medical record numbers, health plan beneficiary numbers, financial institution account numbers, credit card numbers, savings accounts balances, society membership numbers, certificate/license numbers, vehicle identifiers and serial numbers, vehicle license plate numbers, device identifiers and serial numbers (such as the universally unique identifier (UUID) embedded in the appliance user's smart phone, tablet computer or personal computer), Internet Protocol (IP) addresses that the user's appliance uses to communicates over the Internet, and the Media Access Control (MAC) address of the network interface used by the user's appliance; images of the appliance user or the appliance user's friends, family and colleagues; and images of the appliance user's residence, neighborhood, and house of worship.

Although not strictly required for the operation of the preferred embodiment of the present invention, de-identification processing enhances the user of Appliance 345's privacy and security. Such processing can be performed either at the time of SCDME 360's receipt of the consumer data from Appliance 345, shortly thereafter, or after the consumer data is analyzed and the appliance user's anonymous identifier is aggregated with a set of other appliance user anonymous identifiers, as will be later discussed. It could also be performed in Appliance 345 prior to the communication of the appliance user's consumer data to SCDME 360. In this latter case, de-identification processing may not need to be performed by Process 533.

The de-identified consumer data, in the form of decrypted and de-identified CSV text file data, is output from Process 533 and communicated through Inter-process Communication 531 to Data Storage/Retrieval Process 521, where it is communicated through Inter-process Communication 523 to Encryption/Decryption Process 525. After encryption, the data is communicated back to Data Storage/Retrieval Process 521 through Inter-process Communication 523 for storage in encrypted form on Data Storage Unit 509 in Consumer Data Database (DB) 561. Each time SCDME 360 receives a CSV file containing the same appliance user anonymous identifier as a CSV file previously stored in Consumer Data DB 561, regardless of the network connected appliance from which it is received, the received file is communicated to Process 525, decrypted and communicated to Process 533, along with decrypted versions of the stored encrypted CSV files containing the same appliance user anonymous identifier. Process 533 combines the consumer data contained in these files and communicates the combined consumer data file to Process 525 where it is encrypted and communicated to Data Storage/Retrieval Process 521 for storage in encrypted form in Consumer Data DB 561. Thus, consumer data files containing the same appliance user anonymous identifier, received over multiple communications from multiple network connected appliances used by the appliance user, is caused to reside in a single encrypted CSV file in Consumer Data DB 561, so they can be retrieved or processed together. It will be obvious to one skilled in the art that multiple files containing the same appliance user anonymous identifier can be logically linked, allowing them to be retrieved or processed together, and therefore serve in place of, or in addition to, a single file.

Prior to, simultaneously with, or following the receipt, of an encrypted CSV file from Networked Connected Appliance 345, SCDME 360 receives from Media Agency 310 one or more targeted consumer attributes or one or more delineated parameters or selection algorithms, the number of an ad campaign related to these attributes, parameters or algorithms, and the website address of the ad campaign. As shown in FIG. 5, Interface With Media Agency Process 571 uses Network Communication Interface 515 in conjunction with Network Connection line 507, and Data Storage/Retrieval Process 521, through Inter-process Communication 569, to effect communication with Media Agency 310 over FIG. 3 line 380 and store targeted consumer attributes, delineated parameters or selection algorithms, their related ad campaign number, and the related ad campaign website address received from Media Agency 310, in Ad Database 565 on Data Storage Unit 509 of Server 500. Subsequently, Process 571, in conjunction with Data Storage/Retrieval Process 521, directs CPU 513 to retrieve the ad campaign website page from Ad Campaign Website 350, the ad campaign website address received from Media Agency 310, and store it in Temp Storage 567. Such retrieval is effected through line 373, using Network Communication Interface 515 in conjunction with Network Connection line 507. Once retrieved, Generation Of Stable Snapshot Process 573, directs CPU 513 to generate and store in Ad Database 565 a stable snapshot version of the ad campaign website page, metadata derived from analysis of the ad campaign website page content, the ad campaign number associated with the ad campaign, and the website address associated with the ad campaign. As used in this discussion of the preferred embodiment of the present invention, a “stable snapshot” is a copy of a document that has been processed to prevent it from changing over time. Such processing may include: generating the copy, or the copies of the documents pointed to by the hyperlinks in the copy, in a computer readable document format in which the contents of the generated copies can not be readily altered; or generating the copies of the precursor document and the documents pointed to by the hyperlinks in the precursor document in a computer readable format and storing the copies on a storage unit wherein access to the document copies is restricted. The precursor document from which the stable snapshot is generated, could be, for example: a website page, with or without the parent website page's image, graphic, audio, video, or multimedia elements, or the website pages hyperlinked to the parent website page; a compound document, such as a Microsoft Compound Document Format document, with or without spreadsheet, graphic, audio, video, or multimedia elements; an Adobe Portable Document Format (pdf) document; a text document; or any document in any computer readable format.

Although the use of a stable snapshot version of the ad campaign website page is not necessary for the proper operation of the present invention, the use of a stable snapshot version can provide the user of Appliance 345 with a number of benefits. For example, it can increase the appliance user's privacy and security by stripping web beacons, pixel tags, and cookie placement code, among other website user tracking mechanisms, from the version of the ad campaign website page viewed by the appliance user. Additionally, it can provide the appliance user with the ability to find, retrieve, display, and interact with an unchanged version of a previously viewed ad campaign website page. Since the website page obtained from the ad campaign website address provided by Media Agency 310 often contains active and dynamic embedded hyperlinks, subsequent viewings of the website pages pointed to by such embedded hyperlinks may not provide the same information as provided on initial viewing. This is because hyperlinked pages can be changed, for example, by the advertiser, the publisher, the entity contracted to host the ad campaign website, or the entity hosting the hyperlinked content, to name a few. In addition, the main ad campaign website page initially viewed can also change. This “web page aging” and “hyperlink aging” makes it very difficult for Appliance User 345 to obtain the information needed to support a buying decision, unless such decision is made very soon after viewing the initially provided ad campaign website page. In the case of main ad campaign web page aging, information could be added to or deleted from the page, or the advertising creative could be completely different. In the case of the hyperlinks embedded within the main ad campaign web page, hyperlink aging could be manifested by the presence of “broken hyperlinks” that no longer point to any content at all, and when activated presents the appliance user with an error message, broken hyperlinks that point to a modified version of the original hyperlinked content, or broken hyperlinks that point to completely different linked content. In all of these cases, the user of Appliance 345 can no longer access the information previously reviewed and that he or she wants to have current access to.

The present invention's generation and storing, on a server controlled by SCDME 360, of stable snapshot versions of ad campaign website pages helps to mitigate the web page and hyperlink aging issue outlined above. Such stable snapshot versions of ad campaign website pages can be generated by converting the main ad campaign website page, along with each web page pointed to by the hyperlinks in the main ad campaign website page, to a format that cannot be readily changed. To maintain the active nature of the hyperlinks embedded in the main ad campaign website page, the hyperlinks in the generated stable snapshot version of the main page can be changed to point to the stable snapshot versions of the hyperlinked web pages pointed to by the original hyperlinks. Stable snapshot web page versions can be generated in a number of formats. Formats that do not allow the content in documents to be readily changed, permit the use of active hyperlinks and provide documents that are searchable, such as the Acrobat Portable Document Format (PDF), are the most desirable, but other formats can be used. The use of a searchable format for stable snapshot pages can facilitate stable snapshot page content analysis and the generation of metadata that can be used by the user of Appliance 345 to rapidly review or retrieve a new or previously viewed ad. Such metadata could, for example, consist of key words and phrases associated with the ad's content.

Although only one hyperlink level has been discussed, the present invention can accommodate multiple hyperlink levels, even though for most purposes it would not be necessary to provide stable snapshot versions of the content pointed to by web page hyperlinks below a second or third hyperlink level. In this case, level 1 is the main ad campaign website page, level 2 are the web pages pointed to by the hyperlinks in the level 1 main ad campaign page, and level 3 are the web pages pointed to by the hyperlinks in the level 2 web pages.

The following 4 processes, Consumer Data Parsing And Grouping Process 537, Consumer Data Argument Value Generation Process 541, Appliance User Anonymous Identifier Selection Process 545, and Appliance User Anonymous Identifier Aggregate Set Generation And Identification Code Marking Process 549, comprise the 4 stages of appliance user collected consumer data analysis performed by SCDME 360. An encrypted consumer data file is retrieved from Storage Unit 509 from Consumer Data DB 561, through the use of Data Storage/Retrieval Process 521 and Encryption/Decryption Process 525, and communicated in decrypted form through Inter-process Communication 535 to Process 537. Process 537 parses and groups the decrypted file into delineated parameter categories, the delineated parameters having either been directly communicated to SCDME 360 by Media Agency 310, or derived by CPU 513, as directed by Process 537, from targeted consumer attributes or selection algorithms communicated to SCDME 360 by Media Agency 310. In either case, the delineated parameters employed are related to an ad campaign deployed by Media Agency 310. To illustrate using the “Palo Alto example”, the categories could be chosen to correspond to the definitions of arguments ap1-ap6 of the “add-to-aggregate-set?” procedure discussed above. Many text data search programs, such as sgrep and agrep, in combination with scripting languages such as Python, Ruby, Perl. Tcl, Guile, Gauche, and Scsh can be employed to perform this parsing and grouping. The resulting output from Process 537, could be a CSV text file where the first data element of the CSV text file is the appliance user's anonymous identifier, the second element is a date and time stamp data element that indicates the date and time the following data element was collected, and the third element is a collected consumer data element. However, the CSV text file's date and time stamp data and collected consumer data elements are now grouped in accordance with the definitions of arguments ap1-ap6. Such groupings could be delimited by 2 empty element positions in a row, in other words 3 commas directly following one another. As a simplified example, let all ap arguments be equal to zero except for arguments ap1 and ap6. Recall that argument ap1 is defined as: a number from 0 to 100, where 0 indicates the appliance user's collected consumer data shows the appliance user does not visit restaurant review websites, and 100 means the appliance user's collected consumer data shows, on average, the appliance user visits at least 10 restaurant review websites per month. Also recall that argument ap6 is defined as: a number from 0 to 100, where 0 indicates the appliance user's collected consumer data shows the appliance user never remains at a physical location for between 30 and 90 minutes, where at such location at least 1 restaurant is known to be located, and 100 indicates the appliance user's collected consumer data shows the appliance user remains at a physical location for between 30 and 90 minutes, where at such location at least 1 restaurant is known to be located, at least 3 times per week. With ap arguments ap2-ap5 being equal to zero, process 537 deletes all collected consumer data not relating to the definitions of arguments ap1 and ap6 from the data output communicated to the following data analysis process, Consumer Data Argument Value Generation Process 541. Thus, the CSV text file output from Process 537 may contain a sequence of data elements where the first data element contains the appliance user's anonymous identifier, the second data element contains the date and time at which the appliance user visited a restaurant review website, the third data element contains the URL of the restaurant review website visited, the fourth data element contains the date and time at which the appliance user visited a restaurant website, and the fifth data element contains the URL of the restaurant review website visited, which may be the same URL as appeared in the third data element if the appliance user was still visiting the same website when the next appliance user consumer data sample was collected. This sequence continues until no more data pertaining to the definition of ap1 appears in the CSV text file input to Process 537. Immediately following the last data element pertaining to the definition of ap1 could be 3 commas in a row, to indicate that appliance user consumer data related to another ap argument definition, in this case ap6, will now appear in the CSV text file. In accordance with the definition of ap6, the next data element in the sequence contains the date and time the data element was collected, and the following data element in the sequence contains the GPS coordinates of the appliance user's location at the time of consumer data collection. This sequence repeats at the consumer data collection rate until the end of the file.

The parsed and grouped appliance user consumer data CSV text file generated by Process 537 is communicated through Inter-process Communication 539 to Process 541. Process 541 first gathers statistics associated with the consumer data. These statistics may include, but not be limited to, a tabulation of the number of restaurant review websites the appliance user physically visited over the time period during which the data contained in the CSV text file was collected, the number of different locations the appliance user visited over the time period during which the data contained in the CSV text file was collected, the number of times the appliance user visited each location over the time period during which the data contained in the CSV text file was collected, the date and time the appliance user visited the location, the length of time the appliance user remained at each location, and the GPS coordinates of the locations the appliance user remained at for more than 30 minutes but less than 90 minutes. The tabulated data is then analyzed for the purpose of generating consumer data argument values. In this case only arguments ap1 and ap6 are generated because, as previously discussed, all arguments except for arguments ap1 and ap6 have been set to 0 for this simplified example. For the generation of the value of argument ap1, the analysis could employ the number of restaurant review websites the appliance user visited over a period of time. This data is contained in the tabulated appliance user consumer data being analyzed. Given the definition of argument ap1, if the tabulated appliance user consumer data shows the appliance user visited, on average, 5 restaurant review websites per month, ap1 could be assigned a value of 50 as a result of the analysis process. For the generation of the value of argument ap6, the analysis could employ the number of different locations the appliance user physically visited, the number of times the appliance user visited each location, the date and time the appliance user visited the location, the length of time the appliance user remained at each location, and the GPS coordinates of the locations the appliance user remained at for more than 30 minutes but less than 90 minutes. Given the definition of argument ap6, if the tabulated appliance user consumer data shows the appliance user remained at a location for between 30 and 90 minutes, where at such location at least 1 restaurant is known to be located, 1 time per week, apt 6 could be assigned a value of 33 as a result of the analysis process. In order to determine if at least 1 restaurant is located at a location physical visited by the appliance user, the analysis performed by Process 541 could use data obtained by SCDME 360 from Data Sources 325 over line 347, as shown in FIG. 3. In this example, Data Sources 325 provides, among other data, data listing businesses located at or within walking distance from submitted GPS coordinates.

The generated ap argument values are output from Process 541 and communicated through Inter-process Communication 543 to Process 545 along with the appliance user's anonymous identifier. Process 545 employs the communicated ap argument values to determine whether the appliance user's anonymous identifier should be aggregated with a set of other appliance user anonymous identifiers. Process 545 selects the appliance user's anonymous identifier for aggregation if one or more ap argument values derived from the appliance user's collected consumer data is within a predefined ap value range, where each ap argument may utilize a different ap value range. If one or more ap values are not within their predefined range the appliance user's anonymous identifier is not selected for aggregation. The number of ap argument values used could be defined by Media Agency 310 or SCDME 360, and depends on how focused the anonymous identifier selection process is to be. The more ap argument value ranges that need to be satisfied, the more focused the anonymous identifier selection process. A more focused anonymous identifier selection process causes a lower number of anonymous identifiers to be selected for inclusion in the aggregate set of anonymous identifiers. Recall that in this discussion ap argument values indicate the degree the appliance user's collected consumer data satisfies a delineated parameter either directly supplied by Media Agency 310 or derived from targeted consumer attributes supplied by Media Agency 310. The ap value ranges used by Process 545 may be defined in many ways. For example, they may be empirically defined by Media Agency 310 or SCDME 360, defined by Media Agency 310 based on data supplied to Media Agency 310 by Data Sources 325 over Line 303, or defined by SCDME 360 based on data provided to SCDME 360 by Data Sources 325 over Line 347. If the ap value ranges are defined by Media Agency 310, they would be communicated to SCDME 360 over Line 380. Data supplied by Data Sources 325 may include demographic data, GPS location data, web analysis data, other data, or a combination thereof.

Since Process 545 selects appliance user anonymous identifiers for inclusion in the aggregate set of anonymous identifiers whose related analyzed consumer data display one or more ap argument values that fall within one or more predefined ranges, the aggregate set of anonymous identifiers generated by following Appliance User Anonymous Identifier Aggregate Set Generation And Identification Code Marking Process 549 will contain anonymous identifiers that point to appliance users whose consumer data have at least one delineated parameter in common. Previously discussed Scheme procedure “add-to-aggregate-set?” can be used by Process 545 for such appliance user's anonymous identifier selection.

The selected appliance user anonymous identifier is output from Process 545 and communicated through Inter-process Communication 547 to Process 549. Process 549 also receives a file containing a set of appliance user anonymous identifiers to which the appliance user's anonymous identifier is be aggregated with, along with the set's marked identification code. In the preferred embodiment of the present invention, the set is retrieved by Data Storage/Retrieval Process 521 in encrypted form from Anonymous ID Set Database (DB) 563, decrypted by Process 525, and through Inter-process Communication 555, communicated to Process 549. The set may be contained in a text file where each appliance user anonymous identifier is separated from the following identifier by an ASCII line feed character thus causing each identifier to reside on a separate line of the file when the file is viewed, a comma delimited CSV text file where each anonymous identifier is separated from the following identifier by an ASCII comma character, or any other data carrying file capable of being sorted and added to. Subsequent to receiving the decrypted file, Process 549 concatenates the selected appliance user anonymous identifier with the set of appliance user anonymous identifiers contained in the received file. Although concatenation is specified in this example, other combinatorial approaches can be employed to effect the aggregation. The resulting aggregate set of anonymous identifiers may then be sorted in various ways, such as in ascending or descending anonymous identifier order. Such sorting may be effected for the purpose of facilitating the use of the aggregate set of identifiers.

If the file containing the set of appliance user anonymous identifiers to which the appliance user's anonymous identifier is to be aggregated, is any empty file, meaning the appliance user's anonymous identifier is the first identifier to be added to the file, Process 549 marks the generated aggregate set of appliance user anonymous identifiers with a newly created aggregate set identification code, and communicates the aggregate set and its identification code to Data Storage Process 521 through Inter-process Communication 555. If the file containing the set of appliance user anonymous identifiers to which the appliance user's anonymous identifier is to be aggregated has been previously marked, Process 549 may use the existing aggregate set identification code to mark the generated set before communicating the aggregate set and its identification code to Data Storage Process 521. In either case, the aggregate set of appliance user anonymous identifiers generated by Process 549 is marked with an identification code by Process 549 and stored in Anonymous ID Set DB 563 by Process 521, along with the number of the ad campaign whose associated targeted consumer attributes or delineated parameters were employed to generate the aggregate set. Process 549 additionally communicates the aggregate set identification code and its associated ad campaign number to the media agency that provided the targeted consumer attributes, delineated parameters or selection algorithms used to generate the aggregate set, in this case Media Agency 310. This communication is effected by Process 549 through Inter-process Communication 555 in conjunction with Data Storage Process 521, Inter-process Communication 569, Interface With Advertiser, Media Agency, Publisher Process 571, Network Communication Interface 515, and Network Connection Line 507, over FIG. 3 Line 380.

In the following discussion, Process 525 uses public/private key cryptography, although encryption based on other cryptography approaches can be employed, to encrypt the file received by Process 521 from Process 549 containing aggregate set and marked identification code data. The file is encrypted so that the aggregate set and code can be stored by Process 521 in Anonymous ID Set DB 563 with increased security. Strictly speaking, storing the file containing the aggregate set of appliance user anonymous identifiers and aggregate set identification code in encrypted form is not required. However, should the file be accessed by unauthorized entities, encryption will deter such entities from being able to readily use the data contained in the file. This deterrence is an important factor in: a) providing the appliance user with confidence that their consumer data is protected and unavailable to entities who should not have access to their data, and b) facilitating compliance with government consumer data privacy and security regulations.

Pretty Good Privacy (PGP) or Gnu Privacy Guard (GnuPG), as well as other public/private key software programs, can be used for encrypting and decrypting sensitive files. Public-key cryptography refers to a cryptographic system that uses a key pair, one key of the pair is private and the other key of the pair is public. In the preferred embodiment of the present invention, the public key is used to encrypt a file, and the private key is used to decrypt the file. Although different, the two keys of the key pair are mathematically related, but one cannot be derived from the other. Therefore, the public key can be communicated “in the clear” without being protected in any way, as long as the private key remains a secret of the key owner. Prior to the encryption and storage in Anonymous ID Set DB 563 of an aggregate set of appliance user anonymous identifiers generated by Process 549, or the encryption and storage in Consumer Data DB 561 of de-identified and combined consumer data generated by Process 533, Public Private Key Generation Process 529 creates both the public and private keys used by SCDME 360. Since SCDME 360 is the only entity that possesses the private key of the key pair, SCDME 360 is the only entity capable of decrypting the encrypted file.

Selection And Communication Of Ads To Users' Appliance Process 553 can now effect the communication of the ad campaign number, the ad campaign website address, the stable snapshot version of the ad campaign website page, and the stable snapshot's metadata, that reside in Ad Database 565, to Network Connected Appliance 345. When Appliance 345 establishes communication with SCDME 360 through Network Communication Interface 515 in conjunction with Network Connection line 507 and Interface With User Appliance Process 517, for the purpose of communicating collected appliance user consumer data to SCDME 360, Appliance 345 provides SCDME 360 with an encrypted version of the collected consumer data linked with the anonymous identifier of the user of Appliance 345 from which the consumer data was collected. Storage/Retrieval Process 521 stores the data in Temp Storage 567 on Data Storage Unit 509. Process 521 retrieves the encrypted consumer data from Temp Storage 567 and through Inter-process Communication 523 communicates it to Encryption/Decryption Process 525 where it is decrypted and returned to Process 521 for communication to Process 553 through Inter-process Communication 581. Once a decrypted version of the collected consumer data with linked anonymous identifier is available to Process 553, Process 553 can obtain the anonymous identifier of the user of Appliance 345 from the collected consumer data. Using the obtained anonymous identifier, Process 553 retrieves from Anonymous ID Set DB 563 the identification codes of the aggregate sets of appliance user anonymous identifiers that include the anonymous identifier of the user of Appliance 345, as well as the ad campaign numbers associated with these aggregate sets. Process 553 can do this by directing CPU 513 to search for matches between the anonymous identifier of the user of Appliance 345 and the anonymous identifiers that comprise the members of the aggregate sets stored in Anonymous ID Set DB 563. Upon the occurrence of each match, Process 553 directs CPU 513 to provide it with, in decrypted form, the identification code of the aggregate set that the match indicates contains the anonymous identifier of the user of Appliance 345, along with the ad campaign number associated with the aggregate set. On a subsequent communication between SCDME 360 and Appliance 345, or on the same communication, should the process described above be completed before the communication between Appliance 345 and SCDME 360 is terminated, Process 553 uses the obtained ad campaign numbers to retrieve the website addresses of the associated ad campaigns, the stable snapshot versions of associated ad campaign website pages, and the metadata derived from the associated ad campaign website pages' content, from Ad Database 565. The ad campaign numbers, website addresses. stable snapshots, and the metadata associated with the stable snapshots are then communicated to Network Connected Appliance 345.

When Appliance 345 establishes communication with SCDME 360 through Network Communication Interface 515 in conjunction with Network Connection line 507 and Interface With User Appliance Process 517, for the purpose of retrieving a new or previously viewed ad campaign, Appliance 345 provides SCDME 360 with the appliance user's anonymous identifier, a previously received ad campaign number, or key words related to an ad campaign that the user of Appliance 345 would like to see. The ad campaign number can be used by Selection And Communication Of Ads To Users' Appliance Process 553 to directly retrieve from Ad Database 565 the stable snapshot version of the advertising campaign that the user of Appliance 345 is looking for, and communicate it to Appliance 345. The keywords can also be used by Process 553 for this purpose. In this case, Process 553 can employ the searchable nature of the stable snapshot versions of advertising campaigns, or ad campaign metadata, in conjunction with the keywords, to locate, retrieve from Ad Database 565, and communicate to Appliance 345, the stable snapshot version of the desired ad campaign.

The consumer data stored on SCDME 360 Consumer Data DB 561, communicated to SCDME 360 by Appliance 345, becomes, as time progresses, less representative of the appliance user's, likes, dislikes, desires and needs. Consumer data aging occurs because much of the consumer data collected by Appliance 345 reflects the consumer's current activities, age, socioeconomic level, education level, occupation, peer group pressures, and short term plans. In order to take continuous changes in consumer online behavior into account, and be able to assign the appliance user's anonymous identifier to the most appropriate aggregate set of anonymous identifiers, Consumer Data Maintenance Process 575, in conjunction with Inter-process Communication 583 and Data Storage/Retrieval Process 521, can be employed to affect, for example, a “rolling data storage” strategy. In such a strategy, all consumer data communicated to SCDME 360 from Appliance 345 could be stored in Consumer Data DB 561 for an initial period of 6 months, followed by the continued storage in Consumer Data DB 561 of consumer data received from Appliance 345, and the purging from Consumer Data DB 561 of the earliest consumer data received from Appliance 345 every 3 months after the initial 6 month period. Other storage and purging strategies or intervals could be used. Periodic purging of consumer data received from Appliance 345 assures that consumer data analyzed by delineated parameters supplied to SCDME 360 by Media Agency 310, or derived from targeted consumer attributed supplied to SCDME 360 by Media Agency 310, reflects the current online behavior of Appliance 345's user. The periodic purging of received consumer data by SCDME 360 can also positively affect consumer security and privacy. By retaining only limited amounts of appliance user data, appliance users could be far less susceptible to security and privacy compromises should SCDME 360 be impacted by a data breach.

As previously mentioned, SCDME 360 Process 549 communicates the identification code of the aggregate set of anonymous identifiers and its associated ad campaign number to the media agency that provided the targeted consumer attributes, delineated parameters or selection algorithms used to generate the aggregate set, in this example, Media Agency 310. Media Agency 310 can use the aggregate set identification code for a number of purposes. A first purpose can be to communicate additional website pages, related to new, different or the same ad campaign, to the appliance users who previously received Media Agency 310 ad campaign website pages from SCDME 360. In this case the identification code is used to specify the anonymous identifiers pointing to the appliance users who should receive the additional website pages. A second purpose could be to obtain measurements of ad campaign affect from SCDME 360. Such measurements can be generated by SCDME 360 through the use of CPU 513, as directed by Ad Campaign Metrics Process 557. Process 557 can employ consumer data collected from the appliance users to whom the Media Agency 310 ad campaign website pages were communicated, in conjunction with ad campaign impact criteria, to generate ad campaign measurements. In this case the identification code is used to specify the anonymous identifiers pointing to the appliance users who received Media Agency 310 ad campaign website pages. These measurements can provide, for example, numeric quantities indicative of ad campaign reach and ad campaign viewer interaction. In the preferred embodiment of the present invention being discussed, ad campaign impact criteria can be ad campaign metrics algorithms, metrics algorithm arguments, or more general ad campaign effectiveness indicators. Ad campaign impact criteria can be provided to SCDME 360 by Media Agency 310, Advertiser 305, on whose behalf Media Agency 310 is working, an organization contracted by Media Agency 310 or Advertiser 305, or be self created by SCDME 360. When provided in the form of ad campaign metrics algorithms, such algorithms can employ collected consumer data related to, for example, gender, geographic region, age, income level, location, and web browsing history, to name a few, to generate the ad campaign measurements desired by Media Agency 310. Such algorithms could generate, for example:

the ad campaign's cumulative “View Fraction”, where:
view fraction = number of ad campaign views / number of ad campaign

impressions

number of ad campaign views being the cumulative number of

appliance users who looked at the ad campaign a defined time
after ad campaign communication; and

number of ad campaign impressions being the number of appliance users

to whom the ad campaign was communicated;

the ad campaign's cumulative “Conversion Fraction”, where:
conversion fraction = number of ad campaign conversions / number of ad

campaign impressions

number of ad campaign conversions being the cumulative number

of appliance users who purchased ad campaign advertised product
online a defined time after ad campaign communication; and

number of ad campaign impressions being the number of

appliance users to whom the ad campaign was communicated,

and;
the ad campaign's “Demographic Reach Fraction” where:
demographic reach fraction = number of ad campaign views by a

demographic / number of ad campaign impressions

number of ad campaign views by a demographic being the cumulative

number of appliance users of a defined demographic who looked at
the ad campaign
a defined time after ad campaign communication; and

number of ad campaign impressions being the number of

appliance users to whom the ad campaign was communicated.

In addition to ad campaign metrics algorithms that generate measurements of ad campaign reach and ad campaign viewer interaction, the present invention can generate measurements of the affect an ad campaign has on the online behavior of the appliance users who viewed the ad campaign. As previously mentioned, SCDME 360 Process 557 can employ consumer data collected from the appliance users to whom the ad campaign was communicated, in conjunction with ad campaign metrics algorithms provided by the media agency responsible for the ad campaign, to generate ad campaign measurements. Included in the collected consumer data is the date and time at which each element of collected consumer data is acquired and stored. The date and time at which the stable snapshot version of the ad campaign website page and the ad campaign website address is communicated to appliance users is also available, having been recorded and stored at the time of ad campaign website page communication by SCDME 360. Thus, if the media agency provides an algorithm which, for example, calls for the analysis of the consumer data of appliance users before and after viewing the ad campaign, a measurement related to the change in online behavior of appliance users who viewed the ad campaign can be generated. Such an algorithm could generate, for example:

the ad campaign's “Competitive Product Interest Fraction” where:
competitive product interest fraction = ((set members product B views

before / set members product A views before) / (set members
product B views after / set members product A views after))

set members being the appliance users to whom an ad campaign for

product A was communicated.

set members product B views before being the cumulative number of

set members who viewed online websites related to product B
before ad campaign communication;

set members product A views before being the cumulative number of

set members who viewed online websites related to product A
before ad campaign communication;

set members product B views after being the cumulative number of

set members who viewed online websites related to product B
after ad campaign communication; and

set members product A views after being the cumulative number of

set members who viewed online websites related to product A
after ad campaign communication.

As shown in FIG. 4 Block 400, Advertiser 305 initiates an advertising campaign by communicating targeted consumer attributes to Media Agency 310. In Block 402, Media Agency 310 communicates the targeted consumer attributes to DMP 320 over Line 390, and in Block 404, DMP 320 generates delineated parameters or selection algorithms based on the targeted consumer attributes and communicates these parameters or algorithms to Media Agency 310 over Line 390. In Block 406, Media Agency 310 designs the ad campaign initiated by Advertiser 305, based on targeted consumer attributes, delineated parameters or selection algorithms from DMP 320 that are communicated to SCDME 360 in Block 414. Strictly speaking, DMP 320 need not be employed to generate the delineated parameters or selection algorithms communicated to SCDME 360. Delineated parameters or selection algorithms could be generated by Advertiser 305, Media Agency 310, or by SCDME 360 itself, based on targeted consumer attributes provided by Advertiser 305.

The entertainment, news. educational, game, promotional or other content called for by the ad campaign design, is obtained by Media Agency 310 in Block 408 from Content Sources 330 over Line 307. In addition, Media Agency 310 prepares the ad campaign ad copy. As shown in Block 410, Media Agency 310 then generates the ad campaign and assigns the ad campaign an ad campaign ad number. The generated ad campaign is then communicated to Publisher 340 over Line 335 and Publisher 340 publishes the ad campaign to Ad Campaign Website 350 over Line 375, as shown in Block 412. In Block 414, Media Agency 310 communicates the ad campaign number and ad campaign website address, along with related targeted consumer attributes, delineated parameters or selection algorithms, to SCDME 360.

In Block 450 Network Connected Appliance 345 collects appliance user consumer data as a result of the appliance user's use of the appliance and communicates the consumer data, linked with the appliance user's anonymous identifier, to SCDME 360 through line 395 in conjunction with Proxy Server 315 and line 365. SCDME 360 then analyzes the consumer data and aggregates the appliance user's anonymous identifier with the anonymous identifiers of other appliance user's whose collected consumer data meet a delineated parameter or selection algorithm related to the ad campaign whose number was received from Media Agency 310, and marks the generated aggregate set with an identification code, as shown in Block 452. In Block 454, SCDME 360 communicates the aggregate set identification code and related ad campaign number to Media Agency 310. These data can be used by Media Agency 310 to identify an ad campaign that was communicated to the appliance users pointed to by the anonymous identifiers that comprise the aggregate set of anonymous identifiers marked with the provided identification code. Thereafter, Media Agency 310 can direct SCDME 360 to generate and provide measurements of ad campaign affect derived from the collected consumer data communicated to SCDME 360 from the network connected appliances of the appliance users pointed to by the anonymous identifiers that comprise the aggregate set. To facilitate the generation of such measurements, Media Agency 310, in Block 462, communicates one or more ad campaign impact criteria to SCDME 360. In Block 464, SCDME 360 generates at least one ad campaign measurement using the consumer data and the ad campaign impact criteria, and communicates the generated ad campaign measurement or measurements to Media Agency 310.

Following the generation of the aggregate set of anonymous identifiers and the marking of the set with an aggregate set identification code in Block 452, SCDME 360 retrieves the ad campaign website page from the ad campaign website address communicated to SCDME 360 by Media Agency 310 in Block 414. SCDME 360 then generates and stores a stable snapshot version of ad campaign website page with metadata derived from the website page's content, along with the ad campaign number and the ad campaign website address provided to SCDME 360 by Media Agency 310 in Block 414, in Ad Database 565, as shown in Block 456. Following their availability in Block 456, SCDME 360 communicates the ad campaign number, the ad campaign website address, the stable snapshot version of the ad campaign website page, and the stable snapshot's metadata, to the appliance user's network connected appliance, Appliance 345, as shown in Block 458. Although in this discussion of the preferred embodiment of the present invention, SCDME 360 communicates the stable snapshot version of the ad campaign website page, and the snapshot's metadata, to Appliance 345, SCDME 360 could alternatively provide Appliance 345 access to the snapshot version and the snapshot's metadata data by providing Appliance 345 the network address were the snapshot version and snapshot's metadata can be accessed. In Block 460, the user of Appliance 345 views, retrieves, or interacts with the stable snapshot version of the ad campaign or the version of the ad campaign residing on the ad campaign website.

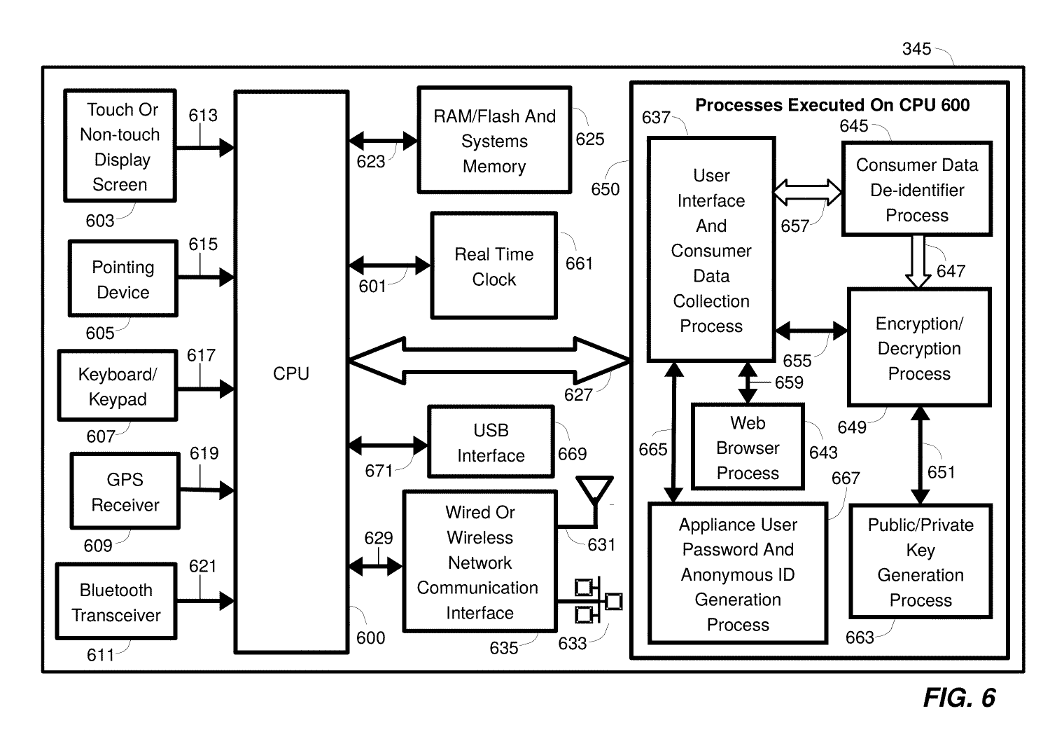

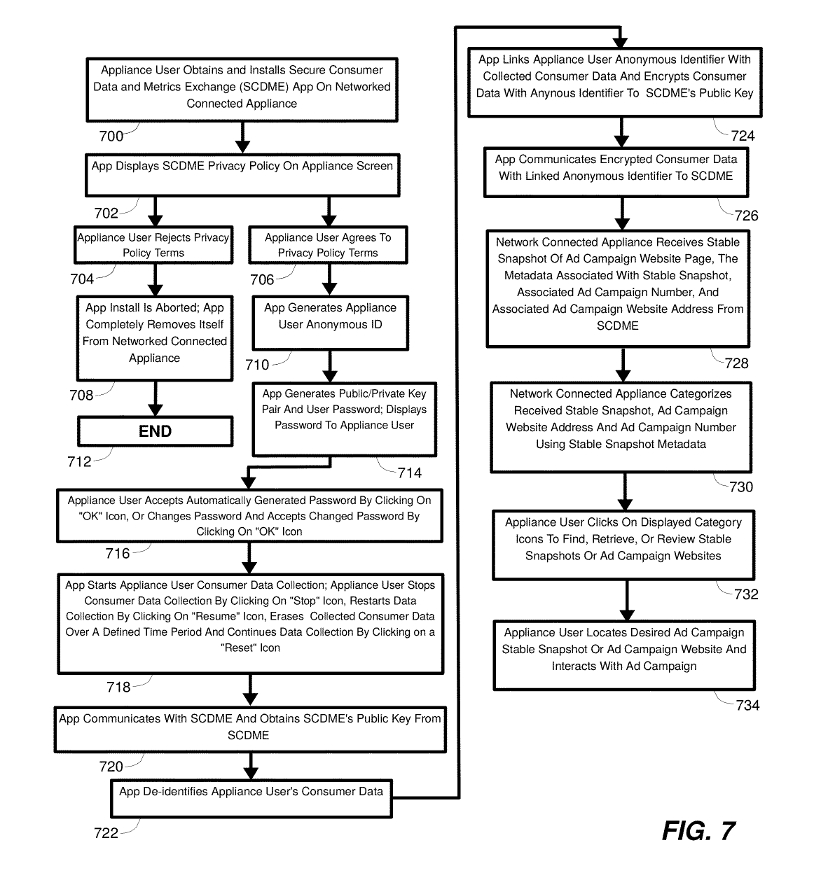

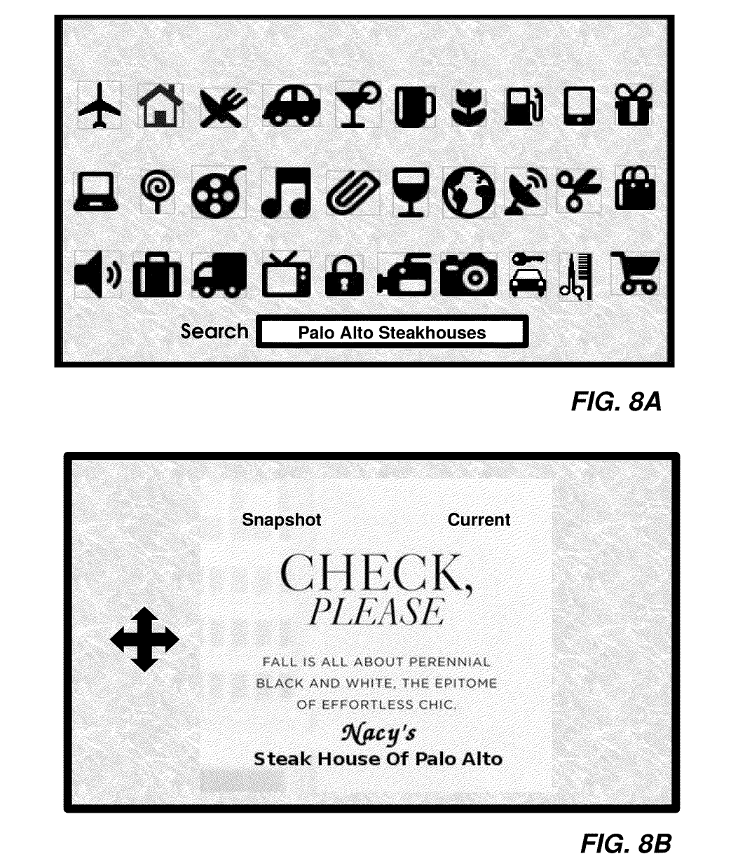

We now turn to FIGS. 6, 7, 8A and 8B to discuss a network connected appliance of the preferred embodiment of the present invention. FIG. 6 is a block diagram of a network connected appliance of the present invention, such as Appliance 345. Although not indicated in FIG. 6, Appliance 345 could be a desktop personal computer (PC), a laptop PC, a notebook PC, a netbook PC, an Ultrabook PC, a Chromebook PC, a tablet computer, a smartphone, a gaming console, a smartwatch, a “Blu-ray” player with Internet connectivity, a smart TV, an Internet TV, an IPTV, a set top box, a digital media receiver (Apple TV, Google TV, or Roku streaming media player, for example), or any other network connected appliance capable of sending or receiving data over a network. FIG. 6 depicts the elements that comprise such an appliance. FIG. 7 is a process flowchart of a network connected appliance of the present invention, and FIGS. 8A and 8B illustrate example ad campaign displays presented to a user of a network connected appliance of the present invention.

The Appliance 345 actions to be discussed are performed by Computer Processor Unit (CPU) 600 of FIG. 6, as controlled by processes executed on CPU 600. Outlined double headed Arrow 627 indicates that Processes 650, which take the physical form of one or more software program applications (apps) stored on RAM/Flash And Systems Memory 625, are executed on CPU 600 to effect such control. In the preferred embodiment of the present invention, RAM/Flash And Systems Memory 625 takes the form of Random Access Memory for program application execution, and flash memory for nonvolatile program application storage. However other forms of memory, such as magnetic hard disk or optical memory may be used for nonvolatile storage, and, in the future, magnetless spin memory (MSM) may be able to be used for program application execution.

As shown in FIG. 7 Block 700, the appliance user first downloads and installs an app from Secure Consumer Data and Metrics Exchange (SCDME) 360 on to Appliance 345. This app may also be downloaded and installed from app distributors, such as Google Play, the Google app store, iTunes, the Apple app store, or Firefox Marketplace, the Firefox app store. It could also be downloaded and installed from another network connected appliance on which the SCDME app has already been installed. Alternatively, the SCDME app could be installed from removable physical media where the SCDME app code resides, where such removable physical media could be a flash drive, SD drive, or optical media, where the optical media could be Blu-ray, DVD, or Compact Disk (CD). Additionally, the SCDME app could be installed in RAM/Flash And Systems Memory 625 at the time of Appliance 345's manufacture.

Through the use of software installed in Systems memory 625 at the time of Appliance 345's manufacture, the acquisition and installation of the SCDME App can be effected by CPU 600 through a number of communication interfaces. These communication interfaces include: Wired Or Wireless Network Communication Interface 635, using Wireless Communication Channel 631, employing Wi-Fi or 4G wireless connections for example, or Wired Communication Channel 633, employing an Ethernet connection for example; Bluetooth Transceiver 611; or Universal Serial Bus (USB) Interface 669. Initiated by appliance user interaction with Display Screen 603, as controlled by User Interface And Consumer Data Collection Process 637, CPU 600 communicates with SCDME 360, for example, through Web Browser Process 643, over a network such as the Internet, the desire of the appliance user to obtain and install the SCDME app. CPU 600 establishes communications with SCDME 360 over Line 629 through the use of Wired Or Wireless Communication Interface 635. Network Communications Interface 635 employs Wireless Communication Channel 631, depicted as an antenna symbol in FIG. 6, for the wireless communication channel, or Wired Communications Channel 633, depicted in FIG. 6 as an Ethernet connector symbol, for the wired communication channel. Once the communications channel between Appliance 345 and SCDME 360 has been established, SCDME 360 communicates the SCDME executable app code to Communications Interface 635, which sends the executable app code over Line 629 to CPU 600. CPU 600 then effects storage of the app code in Systems Memory 625, over line 623, from where it can be executed. Such execution may be started automatically by CPU 600 upon completion of app installation, or by the appliance user clicking on the “Start SCDME” icon that appears on Display Screen 603, as controlled by User Interface Process 637.

As shown in FIG. 7 Block 702, upon execution, the installed SCDME app first displays SCDME 360s's privacy policy on Display Screen 603. In Block 704, the appliance user can reject SCDME 360's privacy policy terms by clicking on the “Reject” icon appearing on Display screen 603. In the case of a non-touch display, the pressing action may be effected by clicking on the Reject icon by the use of a pointing device, such as a mouse. In the case of a touch screen display, the clicking action may be effected by touching the Reject icon with, for example, a finger or s stylus. Once the Reject button is clicked on, the app install is aborted and the app completely removes itself from Appliance 345, as shown in Block 708. The installation process then ends in Block 712. If in Block 706 the appliance user agrees to SCDME 360's privacy policy terms, by clicking on the “Accept” button appearing on Display Screen 603, CPU 600, as controlled by the SCDME app, first generates an appliance user anonymous identifier in Block 710, using Appliance User Password And Anonymous ID Generation Process 667 in communication with User Interface And Consumer Data Collection Process 637 through Inter-process Communication 665. Following this action, as shown in Block 714, CPU 600, as controlled by the SCDME app, generates an appliance user public/private key pair by use of Public/Private Key Generation Process 663 in communication with Encryption/Decryption Process 649 through Inter-process Communication 651, and also generates an appliance user password by use of Appliance User Password And Anonymous ID Generation Process 667. Then, in communication with User Interface And Consumer Data Collection Process 637, through Inter-process Communication 665, CPU 600 displays the generated user password to the appliance user on Display Screen 603. As shown in Block 716, the appliance user may now accept the password for later use, by clicking on the OK icon that appears on Display Screen 603, or change the password to one that the appliance user is more comfortable with, and accept the changed password by clicking the OK icon. The appliance user's password is used by the SCDME app to assure that the appliance user's collected consumer data is linked with the correct appliance user anonymous identifier. This is necessary because a single network connected appliance may be used by multiple appliance users. The password will also be used to assure that ad campaigns communicated to Appliance 345 from SCDME 360 are presented to the appropriate user of Appliance 345.

After the generation of the appliance user's anonymous identifier, public/private key pair, and user password, the SCDME app controls CPU 600 of Appliance 345 to start appliance user consumer data collection, as shown in Block 718. User Interface And Consumer Data Collection Process 637 controls CPU 600 to effect consumer data collection through the use of Touch Or Non-touch Display Screen 603, Pointing Device 605, Keyboard/Keypad 607, or GPS Receiver 609. Such collected consumer data may include, for example, the web addresses of the ad campaign website pages the appliance user visited; the web addresses of the stable snapshot versions of the ad campaign website pages the appliance user viewed, what news articles, entertainment content product descriptions and advertisements were clicked on by the appliance user; the search terms used by the appliance user while searching for Internet content; what products or services were purchased by the appliance user online; what social networking websites, association websites, and blogs the appliance user visited; how long the appliance user remained connected to each website; the physical location of the appliance user at predetermined time intervals; what “brick and mortar stores” the appliance user visited; the date and time each element of collected consumer data is acquired and stored; as well as personal data. Such personal data may include the appliance users name, address and telephone numbers, age, socioeconomic status, place of work, names of friends and acquaintances, number of children, and marital status. In addition, collected consumer data may also include the consumer's network browsing, product purchase, and physical location histories, where such histories include the dates and times at which history events occurred.

If the appliance user of Appliance 345 wishes to use the appliance for “private browsing” or wishes to not have their consumer data collected for any reason, the appliance user can stop SCDME app consumer data collection by clicking on the “Stop” icon that is displayed on Touch Or Non-Touch Display Screen 603 by CPU 600, as controlled by User Interface And Consumer Data Collection Process 637, while Appliance 345 is collecting consumer data. Consumer data collection can be restarted by the appliance user clicking on the “Resume” icon that is displayed on Touch Or Non-Touch Display Screen 603 by CPU 600. If the appliance user of Appliance 345 wishes to erase their collected consumer data over a defined period of time, which includes all consumer data collected to date, for any reason, the appliance user can click on one of a plurality of “Reset” icons that are displayed on Touch Or Non-Touch Display Screen 603 by CPU 600, as controlled by User Interface And Consumer Data Collection Process 637, whether or not Appliance 345 is collecting consumer data at the time. In this user interface example, each icon can be labeled with a period of time over which their consumer data is to be erased. Other user interfaces can be used for entering appliance user consumer data erasure time intervals. Upon the initiation of appliance user consumer data reset, Appliance 345 communicates a directive to SCDME 360, that includes the appliance user's anonymous identifier and the time period over which the appliance user wishes to have their consumer data erased. This directive causes SCDME 360's CPU 513, controlled by Consumer Data Maintenance Process 575, to erase consumer data linked to the appliance user's anonymous identifier previously collected over the defined period of time that resides in Consumer Data DB 561, but continue to accept and store new consumer data linked to the appliance user's anonymous identifier. CPU 600 through Wired Or Wireless Network Communications Interface 635, as controlled by the SCDME app residing in Ram/Flash And Systems Memory 625, can effect communication of such a directive. These potential appliance user actions are also shown in Block 718.

As previously discussed, SCDME 360 receives encrypted consumer data from Appliance 345. In this preferred embodiment of the present invention, the consumer data is encrypted to SCDME 360's public key. It is therefore necessary for Appliance 345 to obtain SCDME 360's public key. Block 720 shows the SCDME app residing in RAM/Flash Systems Memory 625 controlling CPU 600 to use Wired Or Wireless Communication Interface 635 to communicate with SCDME 360, and obtain SCDME 360's public key from SCDME 360.

Prior to linking the consumer data collected by Appliance 345 with the appliance user's anonymous identifier, encrypting the consumer data with anonymous identifier to SCDME 360's public key, and communicating the encrypted consumer data with appliance user's anonymous identifier to SCDME 360, as shown in Blocks 724 and 726, de-identification processing may be performed as shown in Block 722. This optional step enhances consumer privacy and reduces the chances that the consumer data collected by Appliance 345 will be attributed to a particular individual, should there be a security breach at SCDME 360.

If the appliance user of Appliance 345 wishes to de-install the SCDME app, the appliance user can initiate SCDME app de-installation by clicking on the “De-install” icon that is displayed on Touch Or Non-Touch Display Screen 603 by CPU 600, as controlled by User Interface And Consumer Data Collection Process 637. Upon the initiation of the de-installation of the SCDME app from Appliance 345, Appliance 345 communicates a notification to SCDME 360, that includes the appliance user's anonymous identifier, informing SCDME 360 of the apps imminent de-installation from Appliance 345. Such a communication comes from CPU 600 through Wired Or Wireless Network Communications Interface 635, as controlled by the SCDME app residing in Ram/Flash And Systems Memory 625, just prior to the SCDME app's erasure from Systems Memory 625. This notification contains a directive to SCDME 360 to erase all encrypted or non-encrypted consumer data linked to the user of Appliance 345's anonymous identifier. CPU 513 of FIG. 5 effects such consumer data erasure as controlled by Consumer Data Maintenance Process 575. The act of removing all consumer data communicated to SCDME 360 from Appliance 345 residing on Consumer Data DB 561 of Data Storage Unit 509 upon the de-installation of the SCDME app from Appliance 345, facilitates compliance with government consumer privacy legislation and regulations. Such compliance is facilitated by assuring that after the user of Appliance 345 de-installs the SCDME app and “opts out” of having their consumer data collected and communicated to SCDME 360, thus rescinding authorization to do so, consumer data previously collected is no longer available.

During some of the communication sessions established by Appliance 345's CPU 600 with SCDME 360, as controlled by the SCDME app residing in Ram/Flash And Systems Memory 625, wherein collected encrypted consumer data with the linked anonymous identifier of the appliance user are communicated to SCDME 360, Appliance 345 may receive from SCDME 360 a stable snapshot version of a Media Agency 310 ad campaign website page, and the stable snapshot's metadata, along with the ad campaign number and the ad campaign website address. The ad campaign may be promoting products, content, or services from Advertiser 305, on whose behalf Media Agency 310 is working. These 2 actions are shown in Block 726 and Block 728. A communication session between Appliance 345 and SCDME 360 may be initiated by the SCDME app residing in Ram/Flash And Systems Memory 625 at predefined time intervals, such as once per hour, once per day, or a time interval determined to be commensurate with the collection of sufficient consumer data by Appliance 345 to warrant such communication. Communication between Appliance 345 and SCDME 360 may also be initiated when a defined amount of appliance user consumer data is collected. In this latter case, the time interval between communications can vary depending upon how many minutes Appliance 345 is used by the appliance user over a 24 hour time period. In a third approach, appliance user consumer data can be collected and communicated to SCDME 360 when the Appliance user is not using Appliance 345 for data intensive tasks, not using Appliance 345 at all, or when network communication traffic is at a minimum. Other bases for time interval selection are possible.

Upon receipt of a stable snapshot version of a Media Agency 310 ad campaign website page, and the stable snapshot's metadata derived from the snapshot's content, along with the ad campaign number and the ad campaign website address, from SCDME 360, Appliance 345 stores the received snapshot and snapshot metadata in Ram/Flash And Systems Memory 625. By the action of CPU 600, as controlled by the SCDME app stored in Memory 625, Appliance 345 analyzes the stable snapshot's content or the stable snapshot's metadata and uses the results of the analysis to populate an ad campaign database in Memory 625. Such a database structure stores the stable snapshot version of the ad campaign website page, ad campaign website address, and ad campaign number in one or more ad campaign database categories. This is shown in Block 730.

Over time, database categories can be populated with ad campaign data communicated to Appliance 345 from SCDME 360 related to numerous ad campaigns. The user of Appliance 345 can then be presented with a display that facilitates the location, retrieval, review, or interaction with stable snapshots of ad campaign website pages or ad campaign websites. Such a display can be presented by the action of CPU 600 on Touch Or Non-Touch Display Screen 603, as directed by User Interface And Consumer Data Collection Process 637, as controlled by the SCDME app. The display can take many forms. FIGS. 8A and 8B depict a first and a second page of an example display that can be used by the user of Appliance 345 to locate and interact with a desired ad campaign. In FIG. 8A each campaign database category shown is represented by an icon. As depicted in FIG. 8A, the first row of icons can serve as the gateway to ad campaigns related to air travel, housing, restaurants, automobiles, night clubs, coffeehouses, gardening, gasoline, smartphones, and gifts. When the appliance user is interested in finding, for example, a restaurant, the appliance user may click on the icon depicting a knife and fork. This action can cause Display Screen 603 to display a selected ad campaign website page promoting a restaurant believed to be of interest to the user of Appliance 345. This is shown in Block 732 of FIG. 7.

As previously discussed, the ad campaign website pages communicated to Appliance 345 from SCDME 360 are chosen for communication to Appliance 345 based on appliance user consumer data collected by Appliance 345 and analyzed by SCDME 360. An example communicated website page is depicted in FIG. 8B. In FIG. 8B a stable snapshot version of an ad campaign website page from Media Agency 345, promoting “Nacy's Steakhouse of Palo Alto” is shown. The Nacy's ad campaign is one of many ad campaigns that can be presented to the user of Appliance 345. The 4 way arrow in FIG. 8B indicates that the user of Appliance 345 can swipe the screen left, right, up or down to review other restaurant ad campaign website pages, from Media Agency 310 or other media agencies, that may be of interest. To see the complete Nacy's ad campaign stable snapshot, or to be connected to the Nacy's ad campaign website currently hosted on Ad Campaign Website 350 of FIG. 3, and interact with the ad campaign, the user of Appliance 345 can click on the “Snapshot” or “Current” buttons appearing in left and right corners, respectively, of the Nacy's ad campaign stable snapshot depicted in FIG. 8B. Block 734 shows these appliance user actions.

If the user of Appliance 345 concludes that the content, products, or services promoted on the stable snapshot versions of the ad campaign website pages received from SCDME 360 do not accurately reflect his or her interests, the user may wish to erase the consumer data used to determine the ad campaign website pages they receive. In this case, the appliance user can click on the previously discussed “Reset” icon.

To provide the user of Appliance 345 with another way to locate, retrieve, review, or interact with stable snapshots of desired ad campaign website pages, or desired ad campaign websites, a search box is included in FIG. 8A. Keywords entered into the search box by the user of Appliance 345 can be used by CPU 600, as controlled by the SCDME app, to search stable snapshot versions of ad campaign website pages, or stable snapshot version metadata, and find stable snapshot versions of ad campaign website pages whose metadata or included text incorporate entered keywords, words with similar meanings as the entered keywords, or phrases related to the entered keywords. These snapshots and their associated metadata can reside in Appliance 345's Ram/Flash And Systems Memory 625 or in SCDME 360's Ad Database 565. Located ad campaign website pages have a high likelihood of being of interest to the appliance user. Once found, these stable snapshots can be retrieved from Ram/Flash And Systems Memory 625, or communicated to Appliance 345 from SCDME 360, and presented to the appliance user. The appliance user can interact with one or more of these stable snapshots in, for example, the manner previously described in relation to FIG. 8B. Using keywords for the location and retrieval of stable snapshot versions of ad campaign website pages restricts the number of ad campaign website pages the user of Appliance 345 may need to review before finding an ad campaign of interest. In addition, it facilitates the location and retrieval of ad campaign website pages previously reviewed and which the appliance user wishes to see again.

Although the web browsers often incorporated in network connected appliances at the time of manufacture can be employed to communicate with Ad Campaign Website 350, it is preferable, for reasons of consumer privacy, for the SCDME app to include its own web browser. This browser can be designed, for example, such that appliance user tracking objects incorporated into many web pages, such as cookies, local shared objects (LSO) and HTML5 databases, are accepted but not stored, thereby increasing appliance user privacy. Web Browser Process 643 executing on CPU 600 of Network Connected Appliance 345, communicating with User Interface And Consumer Data Collection Process 637, through Inter-process Communication 659, represents such a browser. In the preferred embodiment of the present invention, Web Browser Process 643 is the web browser the user of Appliance 345 employs to access, view and interact with Ad Campaign Website 350.

In accordance with the principles of the present invention, each user who logs into Appliance 345 has a different set of credentials, that is password, anonymous identifier, and public/private key pair. Different user credentials are generated by the SCDME app for each appliance user when he or she first uses Appliance 345. Separate credentials allow consumer data collected by Appliance 345 to be correctly attributed to each appliance user, thus allowing each anonymous identifier included in an aggregate set of anonymous identifiers to point to a single appliance user, not multiple appliance users of a single network connected appliance. However, if an appliance user uses a plurality of network connected appliances, each of these appliances will generate, under the control of the SCDME app, a different set of credentials for the appliance user. This can lead to a single appliance user being associated with a plurality of anonymous identifiers, and a lower volume of collected consumer data associated with each of the appliance user's anonymous identifiers. Since the greater the volume of consumer data associated with an appliance user's anonymous identifier, the more accurate the SCDME's analysis of the data can be, it is advantageous to combine appliance user consumer data collected from each network connected appliance used by the appliance user, into a single combined set of consumer data. One way the preferred embodiment of the present invention effects such combining of consumer data is to cause each network connected appliance employed by the appliance user to incorporate the same appliance user credentials. The synchronization of credentials across multiple appliances employed by the appliance user can be accomplished in a number of ways. A first approach is to physically connect two or more of the user's appliances with an electrical cable, or cables, and, after the appliance user enters his or her passwords for the source and destination appliances, have the appliance user cause the SCDME apps resident on each of the destination user appliances to initiate an encrypted transfer and subsequent installation of credential data, overwriting any credential data previously residing on the destination appliances associated with the appliance user. A second approach can be to use an encrypted wireless communication for the transfer. For example, a Wi-Fi, Bluetooth, Near Field Communication (NFC) or infrared red (IR) optical connection can be employed. Here again the destination user's appliance, or appliances, initiates the encrypted transfer and subsequent installation of credential data. It is important for the destination appliance to initiate transfer and installation of the credential data in order to reduce the potential of such transfer and credential installation being effected by a hacker not associated with the appliance user. Such a wireless transfer can employ Bluetooth Transceiver 611, of Appliance 345, in conjunction with CPU 600, under the control of the SCDME app stored in RAM/Flash And Systems Memory 625.

In the following credential transfer discussion, it is assumed that only a source and a destination user appliance, in this example Destination Appliance 345B and Source Appliance 345A, takes part in the transfer operation. Taking advantage of the appliance user's source and destination appliance public/private keys, destination CPU 600 of Appliance 345B, using destination Bluetooth Transceiver 611, under the control of the destination SCDME app, first communicates to the source CPU 600 of Appliance 345A, under the control of the source SCDME app, the then current public key of the destination appliance. Following this action, CPU 600 of the source appliance, under the control of the source SCDME app, communicates, the public key of the source appliance to the destination appliance. Source CPU 600 then employs source Encryption/Decryption Process 649 to encrypt the source appliance user's credentials to the destination appliance's public key and, over source Inter-process communication 655, in conjunction with source User Interface And Data Collection Process 637, employs source Bluetooth Transceiver 611 to communicate the encrypted source appliance user's credentials to destination Appliance 345B. Destination CPU 600, after receipt of the encrypted source appliance credentials, over destination Bluetooth Transceiver 611, under the control of the destination SCDME app, then decrypts the source appliance user credentials, using destination Encryption/Decryption Process 649 over source Inter-process communication 655, in conjunction with source User Interface And Data Collection Process 637, then overwrites and installs the source appliance's credentials in the destination appliance, in place of the destination appliance's credentials. From this point forward, the appliance user will log into Appliance 345B with the same password as used to log into Appliance 345A, and all consumer data collected and communicated by Appliance 345B to SCDME 360 will be linked to the same anonymous identifier as that which is linked to consumer data collected and communicated to SCDME 360 by Appliance 345A. The appliance user may change his or hers log-in password at any time, on either Appliance 345 A or Appliance 345B, however, the anonymous identifier linked with consumer data collected by either of these appliances will not change. Since SCDME 360 only uses anonymous identifiers linked with received consumer data, and does not employ network connected appliance identifiers, such as UUIDs, or appliance user tracking objects, such as cookies, LSOs and HTML5 databases, to store and combine consumer data received at different times from network connected appliances in which the SCDME app is installed, SCDME 360 will not recognize that such consumer data is communicated from different network connected appliances. Therefore, consumer data communicated to SCDME 360 from a particular network connected appliance user will be combined across all the network connected appliances employed by the appliance user, and appropriately analyzed for enhanced interest in content, products or services offered by an advertiser, such as Advertiser 305. This can result in more accurate assignment of appliance user anonymous identifiers to aggregate sets of appliance user anonymous identifiers, and thereby lead to a higher advertising campaign return on investment.

Having thus described several aspects of the preferred embodiment of the present invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A computer implemented method of effecting targeted access to users of network connected appliances and providing a measurement of the affect of such access, comprising:
communicating to a computer processor unit at a first entity collected consumer data resulting from an appliance user's use of a network connected appliance linked with an appliance user anonymous identifier, wherein processing by the computer processor unit comprises:
analyzing the consumer data by the use of one or more delineated parameters;
aggregating in accordance with the results of the analysis the appliance user's anonymous identifier with a set of appliance user anonymous identifiers linked with the consumer data of other appliance users, generating an aggregate set of appliance user anonymous identifiers, wherein each appliance user anonymous identifier included in the aggregate set points to an appliance user whose collected consumer data corresponds to at least one delineated parameter in common with the collected consumer data of the other appliance users whose anonymous identifiers are included in the aggregate set;
effecting targeted access by a second entity to the appliance users whose anonymous identifiers are included in the aggregate set by use of the anonymous identifiers, wherein the first entity communicates a message to the appliance users from the second entity; and
providing a measurement of message affect to the second entity, wherein the first entity employs one or more message impact criteria and the collected consumer data of the appliance users whose anonymous identifiers are included in the aggregate set to generate the measurement.

2. The method of claim 1 wherein one or more of the delineated parameters are derived from one or more targeted consumer attributes communicated from the second entity to the first entity.

3. The method of claim 1 wherein one or more of the message impact criteria are communicated from the second entity to the first entity.

4. The method of claim 1 wherein the message is a copy of a document that has been processed to prevent it from changing over time.

5. The method of claim 1 wherein the message communicated by the first entity to the appliance users is accompanied by metadata derived from analysis of the message content.

6. The method of claim 1 wherein the date and time the first entity communicates the message from the second entity to the appliance users is recorded and stored.

7. The method of claim 1 wherein the first entity performs de-identification processing on the consumer data.

8. The method of claim 1 wherein the consumer data includes the date and time a consumer data element is collected.

9. The method of claim 1 wherein the consumer data is periodically purged.

10. A network connected appliance for collecting and communicating appliance user consumer data resulting from the appliance user's use of the appliance to a first entity and displaying a communication received from the first entity, comprising:
a processor;
a memory;
a network communications interface;
a display screen; and
a computer program stored in said memory and executed on said processor wherein:
the processor obtains authorization from the appliance user to collect and communicate the appliance user's consumer data to the first entity;
the processor generates an appliance user anonymous identifier;
the processor collects appliance user's consumer data;
the processor links the generated appliance user anonymous identifier with the collected consumer data;
the processor communicates the collected consumer data with the appliance user's anonymous identifier to the first entity by use of the network communications interface;
the processor receives the communication from the first entity by use of the network communication interface, wherein the communication includes a message from a second entity;
the processor categorizes the message based on message content; and
the processor displays the message to the appliance user on the display screen.

11. The appliance of claim 10 wherein the processor displays the message in a category.

12. The appliance of claim 10 wherein the message is accompanied by metadata derived from the message contents.

13. the appliance of claim 12 wherein the message is selected for display by use of the metadata.

14. The appliance of claim 10 wherein the message is a copy of a document that has been processed to prevent it from changing over time.

15. The appliance of claim 10 wherein the processor transfers the appliance user anonymous identifier to a second network connected appliance.

16. The appliance of claim 10 wherein the processor communicates a directive to the first entity to erase the collected consumer data collected over a defined period of time.

17. A system for effecting targeted access to users of network connected appliances and providing a measurement of the affect of such access, comprising:
a computer at a first entity, the computer being comprised of:
a data storage unit;
a processor unit;
a network communications interface; and
software stored on the data storage unit that control processes executed on the processor unit, wherein:
the processor unit receives consumer data resulting from the user's use of the appliance linked with an appliance user anonymous identifier communicated to the processor unit by use of the network communications interface;
the processor unit analyzes the consumer data by use of one or more delineated parameters;
the processor unit aggregates in accordance with the results of the analysis the appliance user's anonymous identifier with a set of appliance user anonymous identifiers linked with the consumer data of other appliance users, and generates an aggregate set of appliance user anonymous identifiers, the aggregate set of appliance user anonymous identifiers comprised of appliance user anonymous identifiers that point to an appliance user whose collected consumer data corresponds to at least one delineated parameter in common with the collected consumer data of the other appliance users whose anonymous identifiers are included in the aggregate set;
the processor unit effects access by a second entity to the appliance users whose anonymous identifiers are included in the aggregate set by use of the anonymous identifiers, wherein the processor communicates a message to the appliance users from the second entity by use of the network communications interface; and
the processor provides a measurement of message affect to the second entity by use of the network communications interface, wherein the processor employs one or more message impact criteria and the collected consumer data of the appliance users whose anonymous identifiers are included in the aggregate set to generate the measurement.

18. The system of claim 17 wherein the processor derives one or more of the delineated parameters from one or more targeted consumer attributes communicated from the second entity to the processor by use of the network communications interface.

19. The system of claim 17 wherein one or more of the message impact criteria are communicated from the second entity to the processor by use of the network communications interface.

20. The system of claim 17 wherein the message communicated by the processor to the appliance users is a copy of a document that has been processed to prevent it from changing over time.
